(19) United States
(12) Patent Application Publication
(10) Pub. No.: US 2013/0280372 A1
(43) Pub. Date: Oct. 24, 2013

(54) CONFECTIONERY PRODUCT AND METHODS OF PRODUCTION THEREOF

(71) Applicants: Peter Clarke, Berkshire (GB); Sarah Marshall, West Berkshire (GB); Clive Richard Thomas Norton, Chatham, NJ (US); Hideki Sakanishi, Tokyo (JP); Devang Sutaria, Landing, NJ (US); Matthew Beam, Alexandria, KY (US); Petros Gebreselassie, Whitehouse Station, NJ (US)

(72) Inventors: Peter Clarke, Berkshire (GB); Sarah Marshall, West Berkshire (GB); Clive Richard Thomas Norton, Chatham, NJ (US); Hideki Sakanishi, Tokyo (JP); Devang Sutaria, Landing, NJ (US); Matthew Beam, Alexandria, KY (US); Petros Gebreselassie, Whitehouse Station, NJ (US)

(21) Appl. No.: 13/583,326

(22) PCT Filed: Mar. 23, 2011
(86) PCT No.: PCT/GB2011/050592

§ 371 Date: Nov. 15, 2012

Related U.S. Application Data
(60) Provisional application No. 61/316,419, filed on Mar. 23, 2010.

(30) Foreign Application Priority Data
Mar. 23, 2010 (GB) 1004900.5

(51) Int. Cl. A23G 3/54

(52) U.S. Cl. CPC A23G 3/545
USPC 426/5; 426/103

(57) ABSTRACT

The present invention relates to a confectionery product including an extruded body portion; and a plurality of capillaries the extruded body portion, in which the body portion includes a mixture of confectionery compositions, particularly, a hard candy composition and a chewing gum composition. The invention also relates to a process of manufacturing the same.

### TECHNICAL FIELD OF THE INVENTION

The present invention relates to confectionery and method of production thereof. In particular, the invention relates to confectionery comprising one or more capillaries which may contain a fluid or other material.

### BACKGROUND TO THE INVENTION

It is desirable to produce confectionery formed of different components, so as to increase sensory pleasure. A number of confectionery products exist, which have a flavoured liquid or syrup centre which is released upon chewing. For example, WO2007056685 discloses an apparatus and method for the continuous production of centre-filled confectionery products in the format of a continuous extrudate having a plurality of centre-filled confectionery ropes. Whilst a product formed from such an apparatus does increase sensory pleasure, the period of pleasure is often short lived as the centre is released quickly and/or degraded. Some embodiments of the present invention can provide a confectionery product which can release a fluid centre over an extended period of time.

There is also a demand for providing confectionery having a reduced fat or sugar content. Some embodiments of the present invention can provide a confectionery product which can be produced having a lowered fat or sugar content, whilst still maintaining an excellent sensory pleasure.

It is an aim of an embodiment or embodiments of the present invention to overcome one or more of the problems of the prior art. It is also an aim of some embodiments of the present invention to provide a confectionery having an extended fluid fill release profile and a method of manufacture thereof. It is also a further aim of some embodiments of the present invention to provide a confectionery which has a reduced fat and/or sugar profile and a method of manufacture thereof.

### SUMMARY OF THE INVENTION

The present invention relates to confectionery products including an extruded body portion having a plurality of capillaries disposed therein. In accordance with some embodiments, the extruded body portion is a mixture of two or more confectionery compositions, such as hard candy and chewing gum compositions, hard candy and chewy candy compositions, chewy candy and chewing gum compositions, chewy candy and chocolate compositions and the like. The confectionery compositions may be homogenously mixed in some embodiments or non-homogenously mixed in some other embodiments. The extruded mixture of confectionery compositions, as well as the plurality of capillaries disposed therein, can impart a unique textural, sensorial and taste profile to the overall confectionery product.

In some embodiments, the body portion may be formed from a material which is liquid during extrusion and which has a plurality of capillaries disposed therein, the capillaries having a width or diameter or longest cross-sectional dimension of no more than 3 mm.

Some embodiments of the present invention therefore provide for a confectionery product which can be used in confectionery having an extended release of one or more materials inserted into the capillaries, or a confectionery product having a large voidage so as to reduce the amount confectionery material used in the product, whilst maintaining the overall size of the product.

It should be understood that the term “liquid” is intended to mean that the material is capable or has a readiness to flow, including gels, pastes and plasticized chocolate. Furthermore, this term is intended to include (but not limited to) those materials which may be “molten” during extrusion and the skilled addressee will understand that the term “molten” means that the material has been reduced to a liquid form or a form which exhibits the properties of a liquid.

It should be understood that the term “plurality” is intended to mean two or more. In some embodiments, a plurality is 3 or more, or 4 or more, or 5 or more, or 6 or more, or 7 or more. There is no particular upper limit on the number associated with “plurality”. In the context of the phrase “plurality of capillaries”, numbers up to 50 and higher are contemplated.

It should be understood that the term “capillary” generally refers to a conduit or space created by an extrusion or other forming process within the body of the product. The capillary typically contains matter, and that matter can be in the form of a gas, a liquid, a solid, or a mixture thereof.

It should be understood that the term “voidage” generally refers to the volume percent of the capillary volume relative to the sum of the capillary volume and the extruded body portion volume. That is voidage (%)=100× capillary volume/(capillary volume+extruded body portion volume). In some embodiments, the extruded body portion volume does not include any central region volume created by certain dies, such as an annular die.

The body portion may be at least partially or substantially solid, so that it can no longer be considered to flow in a liquid form.

The material used to produce the body portion may comprise a number of materials commonly use in the production of confectionery—such as mixtures of candy, gum, chocolate, etc.

As described above, in some embodiments, the extruded body portion is a mixture of confectionery compositions, such as, for instance, hard candy and chewing gum compositions. The extruded mixtures can provide unique textural profiles to the final confectionery products, which may be varied depending upon the confectionery compositions selected, the ratios employed, the product composition desired, the manufacturing process used, the final product characteristics desired, etc. The products may exhibit a textural transformation during consumption due to the presence of the different types of confectionery compositions. For instance, a mixture of hard candy and chewing gum compositions may start out with a crunchy texture due to the hard candy. The product may then transform into a chewing experience as the candy is consumed and only chewing gum remains. The plurality of capillaries disposed in the extruded body portion will further add to the overall textural profile of the product. Air-filled capillaries can alter the texture of the product, making it less dense, thereby providing a unique overall textural profile. Further, if the capillaries are filled with a fill material which differs in texture, sensation, viscosity, solubility, taste, flavor, etc. from that of the body portion, this can further enhance the overall taste, textural and/or sensorial experience of the product upon consumption.

In some embodiments, the confectionery compositions employed in the extruded body portion may be fully prepared confectionery compositions, rather than simply the separate starting ingredients of each composition. For instance, fully prepared and cooked hard candy compositions may be mixed with fully prepared chewing gum compositions, rather than simply mixing the separate starting materials of a candy base, e.g., sugars or sugar substitutes, and a chewing gum base. Such mixtures can be extruded together to form homogenous mixtures of the combined confectionery compositions. Alternatively, in some other embodiments, the extruded body portion may be formed from a mixture of simply the starting base materials, such as the cooked saccharide syrup base of a hard candy and a gum base. In such embodiments, other typically included confectionery ingredients can be added separately or at later stages of the process.

For instance, additives such as flavors and sweeteners could be incorporated into the capillaries of the product rather than in the body portion. During consumption, these components could mix together in the oral cavity with the confectionery bases in the body portion to complete the overall product.

In some embodiments, the capillaries disposed in the extruded body portion can be at least partially filled with one or more fill materials, such as, but not limited to, liquid fill materials. The fill materials contained in the capillaries may be homogenously or non-homogenously mixed. The capillaries each may contain one or more fill materials that are the same or different and different capillaries may contain fill materials with different colors, flavors, flavor combinations, color combinations, flavor intensities, color intensities, viscosities, solubilities, densities, textures, fill percentages, materials, material combinations (e.g., combinations of liquid and suspended particulates within the liquid), material ratios, functional strengths, aftertastes, sensory profiles, temporal profiles, mechanisms of action (chemical, mechanical, trigeminal, receptor, exothermic, endothermic), locations of action (e.g. tongue, throat), odors, hydrophobicities, hygrophobicities, water activities, barrier properties, reactions to air and/or water, chemical stabilities, changes over time (e.g., solid to liquid, liquid to solid), shelf life characteristics, crystal structures, etc.

In some embodiments, liquid fill materials can include particulates suspended therein, such as, but not limited to, sugars, fruit pieces, nut pieces, powdered ingredients and the like.

In some embodiments, two or more capillaries may have the same or different size, cross-section (e.g., circle, oval, square, triangular, star-shaped), cross-sectional area, circumference, etc. One or more capillaries also may be continuous or discontinuous within the body portion.

In accordance with some embodiments of the present invention, there is provided a confectionery product including: an extruded body portion; and a plurality of capillaries disposed in the extruded body portion, wherein the body portion includes a mixture of a hard candy composition and a chewing gum composition. In some embodiments, the extruded body portion includes a homogenous mixture of a hard candy composition and a chewing gum composition. The extruded mixture of hard candy and chewing gum compositions can produce a confectionery product that provides a unique textural transformation during consumption, as described above. The product can provide an overall chewing experience like a chewing gum, but can initiate with a crunchy texture due to the presence of the hard candy.

In some embodiments, the ratio of the hard candy composition to the chewing gum composition is about 10:90 to 50:50. In some other embodiments, the ratio of the hard candy composition to the chewing gum composition is about 20:80 to 40:60. In still other embodiments, the ratio of the hard candy composition to the chewing gum composition is about 30:70. The ratio of hard candy to chewing gum can be varied to achieve the desired final product attributes. The higher the hard candy content, the more crunchy of a texture the final product will have and less chewing experience.

Moreover, the combination of hard candy and chewing gum compositions may impart stability to the capillaries disposed in the body portion of the product. It is thought that the hard candy may lend to making the chewing gum composition less porous and more like the glassy matrix of a hard candy. This blend may help to impart stability and structural integrity to the body portion and thereby prevent collapse and/or leakage of fill material from the capillaries disposed therein. Accordingly, it may be possible to incorporate fill materials having a higher moisture and/or fat content into the capillaries of such a product than can be incorporated into a conventional chewing gum without concern for migration of all or portions of the fill material into the body portion.

In addition, it is thought that this product format may be particularly useful for producing hard candy gum products as it can utilize the capillaries to release flavor during consumption. Conventional candy gums often lack flavor in the transition between the candy and gum phases of the product until the flavor begins to chew out of the chewing gum or otherwise becomes available from the chewing gum. In some embodiments of the present invention, the fill material contained in the capillaries may be adapted to release at the outset of the chewy phase of the product. This can provide a flavor burst at the outset of the chewy phase thereby providing a smoother flavor transition than conventional candy gums.

In some embodiments, the hard candy composition employed in the body portion is a fully prepared, or cooked, hard candy composition. The hard candy composition may have a moisture content of about 2-4% by weight. The hard candy composition may be sugared or sugar-free. Such compositions include a hard candy base. In some embodiments, the hard candy composition, particularly the hard candy base, includes a cooked saccharide syrup. In some embodiments, the hard candy composition, particularly the hard candy base, includes at least one polyol selected from maltitol, sorbitol, erythritol, isomalt and combinations thereof.

In general, the hard candy compositions may include bulk sweeteners such as sugars and sugarless bulk sweeteners, or the like, or mixtures thereof. Bulk sweeteners generally are present in amounts of about 0.05% to about 99% by weight of the composition.

In some embodiments, high-intensity sweeteners also may be included in the hard candy compositions. Without being limited to particular sweeteners, representative categories and examples include:
(a) water-soluble sweetening agents such as dihydrochalcones, monellin, steviosides, glycyrrhi7in, dihydroflavenol, and sugar alcohols such as sorbitol, mannitol, maltitol, xylitol, erythritol, and L-aminodicarboxylie acid aminoaikenolc acid ester amides, such as those disclosed in U.S. Pat. No. 4,619,834, which disclosure is incorporated herein by reference, and mixtures thereof;
(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-],2,3-oxathiazine-4-one-2,2-dioxide (Acesulfame-K), the free acid form of saccharin, and mixtures thereof;
(c) dipeptide based sweeteners, such as L-aspartic acid derived sweeteners, such as L-aspartyl-L-phenylalanine methyl ester (Aspartame), N—[N-(3,3-dimethylbutyl)-L-α-aspartyl]-L-phenylalanine 1-methyl ester (Neotame), and materials described in U.S. Pat. No. 3,492,131, L-alphaaspartyl-N-(2,2,4,4-tetramethyl-3-thietanyl)-D-alaninamide hydrate (Alitame). methyl esters of L-aspartyl-L-phenylglycerine and L-aspartyl-L-2,5-dihydrophenyl-glycine, L-aspartyl-2,5-dihydro-L-phenylalanine; L-aspartyl-L-(\ddot{τ}-cyclohexenj-alanine, and mixtures thereof;
(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose: examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4J′-dideoxygalactosucrose; 1′,6′-dichlorol′,6′-dideoxysucrose; 4-chloro-4-deoxy-alpha-D-galactopyranosyl-1.6-dichloro-16-dideoxy-beta-D-fructofuranoside, or 4,r,6′-trichloro-4,r,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; and 4,6,1′,6′-tetradeoxy-sucrose, and mixtures thereof;
(e) protein based sweeteners such as thaumaoccous danielli (Thaumatin 1 and II) and talin;
(f) the sweetener monatin (2-hydroxy-2-(indo]-3-ylmethyl)-4-aminoglutaric acid) and its derivatives; and
(g) the sweetener Lo han guo (sometimes also referred to as “Lo han kuo”).

The intense sweetening agents may be used in many distinct physical forms well-known in the art to provide an initial burst of sweetness and/or a prolonged sensation of sweetness.

Without being limited thereto, such physical forms include free forms, such as spray dried, powdered, beaded forms, encapsulated forms, and mixtures thereof. In general, an effective amount of intense sweetener may be utilized to provide the level of sweetness desired, and this amount may vary with the sweetener selected. The intense sweetener may be present in amounts from about 0.001% to about 3%, by weight of the comestible, depending upon the sweetener or combination of sweeteners used. The exact range of amounts for each type of sweetener may be selected by those skilled in the art.

A variety of traditional ingredients also may be included in the hard candy compositions in effective amounts such as coloring agents, antioxidants preservatives, and the like. Coloring agents may be used in amounts effective to produce the desired color. The coloring agents may include pigments which may be incorporated in amounts up to about 6%, by weight of the composition. For example, titanium dioxide may be incorporated in amounts up to about 2%, and preferably less than about 1%, by weight of the composition. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No. 2. which is the disodium salt of 5,5-indigotindisulfonic acid. Similarly, the dye known as F.D.& C. Green No. 1 comprises a triphenylmethane dye and is the monosodium salt of 4-[4-(N-ethyl-p-s αlfoniumbenzylamino) diphenylmethylene]-[1-(N-ethyl-N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

Lubricants also may be added in some embodiments to improve the smoothness of the hard candy composition. Smoothness is a characteristic that leads to an increased perception of hydration upon consumption. Suitable lubricants include, but are not limited to fats, oils, aloe vera, pectin, and combinations thereof.

Other conventional additives known to one having ordinary skill in the art also may be used in the hard candy compositions.

In some embodiments, hard candy compositions can be produced by batch processes. Such confections may be prepared using conventional apparatus such as fire cookers, cooking extruders and/or vacuum cookers. In some embodiments, the bulk sweetener (sugar or sugar free) and a solvent (e.g., water), are combined in a mixing vessel to form a slurry. The slurry is heated to about 70° C. to 120° C. to dissolve any sweetener crystals or particles and to form an aqueous solution. Once dissolved, heat and vacuum are applied to cook the batch and boil off water until a residual moisture of less than about 4% is achieved. The batch changes from a crystalline to an amorphous, or glassy, phase. Optional additives, such as coloring agents, flavorants, and the like can then be admixed in the batch by mechanical mixing operations. The batch is then cooled to about 50° C. to 10° C. to attain a semi-solid or plastic-like consistency.

The optimum mixing required to uniformly mix the flavors, colorants and other additives during manufacturing of hard confectionery is determined by the time needed to obtain a uniform distribution of the materials. Normally, mixing times of from four to ten minutes have been found to be acceptable. Once the candy mass has been properly tempered, it may be cut into workable regions or formed into desired shapes having the correct weight and dimensions.

Alternatively, various continuous cooking processes utilizing thin film evaporators and injection ports for incorporation of ingredients are known in the art and can be used as well. The apparatus useful in accordance with the present invention comprise cooking and mixing apparatus well known in the confectionery manufacturing arts, and selection of specific apparatus will be apparent to one skilled in the art.

In some embodiments, the chewing gum composition employed in the body portion is a fully prepared chewing gum composition, including gum base, bulk sweeteners, flavors, softeners, fillers and the like. In some embodiments, the chewing gum composition includes a chewing gum base. In some other embodiments, only the chewing gum base is included in the body portion and the remaining chewing gum ingredients are incorporated into the fill material in the capillaries. The chewing gum composition may be sugared or sugar-free. In some embodiments, the hard candy composition and the chewing gum composition both may be sugared or both may be sugar-free. In some other embodiments, one of the compositions may be sugared and the other may be sugar-free.

Chewing gum compositions typically include one or more of gum bases, flavoring agent and bulk sweeteners. Chewing gum also includes bubble gums.

The chewing gum composition includes gum base and most of the other typical chewing gum composition components such as sweeteners, softeners, flavoring agents and the like.

In some embodiments, the gum base generally includes elastomers, elastomer plasticizers, waxes, fats, oils, emulsifiers, fillers, and texturizers. Elastomers to constitute from about 5% to 95% by weight of the base, specifically 10% to 70% by weight and more specifically 15% to 45% by weight. Examples of elastomers include synthetic elastomers such as polyisobutylene, polybutylene, isobutylene-isoprene co-polymers, styrene-butadiene co-polymers, polyvinylacetate and the like. Elastomers may also include natural elastomers such as natural rubber as well as natural gums such as jelutong, lechi caspi, perillo, massaranduba balata, chicle, gutta hang kang or mixtures thereof. Other elastomers are known to those of ordinary skill in the art.

Elastomer plasticizers modify the firmness of the finished gum when used in the gum base. Elastomer plasticizers are typically present in an amount of up to about 75% by weight of the gum base, specifically from about 5% to 45% by weight and more specifically from about 10% to 30% by weight. Examples of elastomer plasticizers include natural rosin esters such as glycerol ester of partially hydrogenated rosin, glycerol ester of tall oil rosin, pentaerythritol esters of partially hydrogenated rosin, methyl and partially hydrogenated methyl esters of rosin and the like. Synthetic elastomer plasticizers such as terpene resins may also be employed in gum base composition.

Waxes include synthetic and naturally occurring waxes such as polyethylene, bees wax, carnauba and the like. Petroleum waxes such paraffin may also be used. The waxes may be present in the amount of up to about 30% by weight of the gum base. Waxes aid in the curing of the finished gum and help improve the release of flavor and may extend the shelf life of the product.

Fillers modify the texture of the gum base and aid processing. Examples of such fillers include magnesium and aluminum silicates, clay, alumina, talc, titanium oxide, cellulose polymers, and the like. Fillers are typically present in an amount of from 1% to 60% by weight.

Examples of softeners used in the gum base include hydrogenated and partially hydrogenated vegetable oils, cocoa butter, glycerol monoslearate, glycerol triacetate, di- and triglycerides, fatty acids such as stearic acid, palmitic acid, oleic acid, linoleic acid, linolenic acid and the like.

The gum base constitutes between about 5% and 95% by weight of the chewing gum composition, more typically about 10% to 50% by weight and most typically from about 25% to 35% by weight of the chewing gum composition.

Other ingredients used in chewing gum compositions include sweeteners, both natural and artificial and both sugar and sugarless. Sweeteners are typically present in the chewing gum compositions in amounts of from about 20% to 80% by weight specifically from about 30% to 60% by weight. Sugarless sweeteners include, but are not limited sugar alcohols, such as sorbitol, mannitol, maltitol, xylitol, isomalt, erythritol, hydrogenated starch hydrolysates, and the like. High intensity sweeteners, such as sucralose, aspartame, neotame, salts of acesulfame, monatin, and the like are typically present in amounts of up to about 1.0% by weight.

Flavoring agents, which can vary over a wide range, may be selected in amounts from about 0.1% to 10.0% by weight, specifically from about 0.5% to 5.0% by weight. Flavoring agents for use in chewing gum compositions are well known and include citrus oils, peppermint oil, spearmint oil, oil of wintergreen, menthol, cinnamon, ginger and the like.

Softeners may be present to modify the texture of the chewing gum composition. As in typical gum compositions, softeners in the compositions are typically present in amounts of from about 0.5% to 10% by weight based on the total weight of the chewing gum composition.

Other materials, which may be present in the gum composition include antioxidants (e.g. butylated hydroxyanisole, butylated hydroxytoluene, beta-carotenes, tocopherols), colorants, flavoring agents and the like.

Further details regarding the preparation of chewing gum compositions can be found in Skuse's Complete Confectioner (13th Edition) (1957) including pp. 41-71, 133-144, and 255-262; and Sugar Confectionery Manufacture (2nd Edition) (1995), E. B. Jackson, Editor, pp. 258-286, the content of which is incorporated herein by reference.

In another embodiment of the present invention, there is provided a confectionery product including: an extruded body portion; and a plurality of capillaries disposed in the extruded body portion, wherein the body portion includes a chewy candy composition and a chewing gum composition.

In some embodiments, the body portion includes a homogenous mixture of the chewy candy composition and the chewing gum composition. The mixture of chewy candy and chewing gum compositions can produce a confectionery product that provides an overall chewy texture and a chewing experience like a chewing gum. In some embodiments, the ratio of the chewy candy composition to the chewing gum composition is about 10:90 to 50:50. In some other embodiments, the ratio of the chewy candy composition to the chewing gum composition is about 20:80 to 40:60. In still other embodiments, the ratio of the chewy candy composition to the chewing gum composition is about 30:70.

As described above for the mixtures of the hard candy and chewing gum compositions, the chewy candy and chewing gum compositions may be sugared or sugar-free. Both compositions may be sugared or sugar-free, or one may be sugared and the other may be sugar-free. Any of the chewing gum compositions described above may be employed in such embodiments.

The chewy candy compositions, also referred to as “soft” candy compositions, employed in some embodiments can include nougat, caramel, taffy, gummies and jellies.

In some embodiments, a nougat composition can include two principal components a high boiled candy and a frappe. By way of example, egg albumen or substitute thereof is combined with water and whisked to form a light foam.

Sugar and glucose are added to water and boiled typically at temperatures of from about 130° C. to 140° C. and the resulting boiled product is poured into a mixing machine and beaten until creamy. The beaten albumen and flavoring agent are combined with the creamy product and the combination is thereafter thoroughly mixed.

In some embodiments, a caramel composition can include sugar (or sugar substitute), corn syrup (or polyol syrup), partially hydrogenated fat, milk solids, water, butter, flavors, emulsifiers, and salt. To prepare the caramel, the sugar/sugar substitute, corn syrup/polyol syrup, and water can be mixed together and dissolved over heat. Then, the milk solids can be mixed into the mass to form a homogeneous mixture. Next, the minor ingredients can be mixed in with low heat. The heat can then be increased to boiling. Once sufficient water is removed and color/flavor developed, the mass can be cooled somewhat and temperature sensitive ingredients can be mixed in prior to discharging.

In some embodiments, a taffy composition can include sugar (or sugar substitute), corn syrup (or polyol syrup), partially hydrogenated fat, water, flavors, emulsifiers, and salt. The process for preparing taffy can be similar to that for caramel and, optionally, the final taffy mass can be pulled to develop its desired texture.

In some embodiments, a gummi composition can include sugar (or sugar substitute), corn syrup (or polyol syrup), gelatin (or suitable hydrocolloid), flavor, color, and optionally acid. The gummi can be prepared by hydrating the gelatin or suitable hydrocolloid, heating the sugar/corn syrup (sugar substitute/polyol syrup) and combining the two components with heat. Once the combined mixture reaches its final temperature or suitable sugar solids level, minor components such as flavor, color, etc. can be incorporated into the mixture.

In some embodiments a jelly composition can include a starch-based jelly or a pectin-based jelly. As with gummies, jelly products can be produced by hydrating the hydrocolloid and combining the hydrated mixture with a cooked syrup component. The mixture can then be cooked to a final moisture content and minor components can be incorporated.

In yet another embodiment of the present invention, there is provided a confectionery product including: an extruded body portion; and a plurality of capillaries disposed in the extruded body portion, wherein the body portion comprises a chewy candy composition and a hard candy composition. In some embodiments, the body portion includes a homogenous mixture of the chewy candy composition and the hard candy composition. The mixture of hard candy and chewy candy compositions can produce a confectionery product that provides a chewy experience like a chewy candy, but initiates with a crunchy texture due to the presence of the hard candy. In some embodiments, the ratio of the hard candy composition to the chewy candy composition is about 10:90 to 50:50. In some other embodiments, the ratio of the hard candy composition to the chewy candy composition is about 20:80 to 40:60. In still other embodiments, the ratio of the hard candy composition to the chewy candy composition is about 30:70.

As described above for the mixtures of the hard candy and chewing gum compositions, the chewy candy and hard candy compositions may be sugared or sugar-free. Both compositions may be sugared or sugar-free, or one may be sugared and the other may be sugar-free. Any of the chewy candy compositions and the hard candy compositions described above may be employed in such embodiments.

In some embodiments, the body portion includes a chocolate composition. Suitable chocolate includes dark, milk, white and compound chocolate. In some embodiments, the body portion includes chewing gum, bubble gum or gum base. For instance, the body portion may include the gum base and the remaining chewing gum ingredients may be incorporated into the fill material in the capillaries. In other embodiments, the body portion includes a candy composition. Suitable candy includes hard candy, chewy candy, gummy candy, jelly candy, toffee, fudge, nougat and the like.

The capillaries may extend along the substantially entire length of the body portion, but may in some embodiments extend no less than 75%, 80%, 90%, 95% or 99% along the length of the body portion (for example, when it is desired to seal the ends of the body portion). If the capillaries extend along the entire length of body portion, suitably the ends of the capillaries are visible at one or more ends of the body portion.

In some embodiments, the capillaries may remain unfilled, or partially or completely air-filled. In some other embodiments, one or more of the capillaries may be filled with a material which is different from that of the material used to form the body portion. Some embodiments may include a group of capillaries that are unfilled, or air-filled, and another group of capillaries that are at least partially filled with a fill material. Different capillaries may incorporate different materials if desired. The capillaries may be at least partially filled with a fluid or other material. Such a fluid may comprise a liquid. The capillaries may be filled with a material which is solid at a room temperature and fluid at a temperature greater than room temperature. For example, a molten chocolate may be incorporated into the capillaries and allowed to set when cooled to room temperature. It will be apparent to the skilled addressee that room temperature is commonly regarded as around 20° C. Alternatively, the capillaries may be filled with a material which is deposited as a liquid and which subsequently solidifies. In such embodiments, the solidification may be dependent or independent of heat. It will be apparent that solidification of a liquid filled capillary may be achieved in a number of ways. For example solidification may take place due to one or more of the following:
Cooling—the filling may be molten when deposited which then cools to a solid at room temperature;
Heating—the filling may be liquid when deposited, and the heat of the extruded body portion sets the filling (e.g. pumping egg albumen into a hot hard candy extruded body portion will set the egg on contact);
Drying—the filling may be a solution that dries into a solid (e.g. the moisture from the solution is absorbed into the extruded body portion);
Solvent loss—the filling may be in a solvent, whereby the solvent is absorbed into the extruded body portion, leaving a solid;
Chemical reaction—the filling may be deposited as a liquid but reacts or “goes off” into a solid;
Cross-linking—the filling may form a constituents for a cross-linked material due to mixing and/or heating; and
Time—the filling may simply set with time (e.g. a solution of sugars and gelatin will eventually set over time).

Suitable filling materials for the capillaries include, but are not limited to, aqueous media, fats, chocolate, caramel, cocoa butter, fondant, syrups, peanut butter, jam, jelly, gels, truffle, praline, chewy candy, hard candy or any combination or mixture thereof.

If desired, the product may further comprise a coating portion to envelop the body portion. The skilled addressee will appreciate that a number of coatings could be employed—for example chocolate, gum, candy and sugar etc.

The body portion may be connected to one or more further confectionery portions. In some embodiments, the body portion is sandwiched between confectionery materials or may be connected or laminated to one or more confectionery layers. The further confectionery portion or portions may or may not contain inclusions, liquid-filled beads etc.

In some embodiments, the capillaries are distributed substantially uniformly throughout the body portion, and may be spaced evenly apart from adjacent capillaries. In other embodiments, the capillaries may be distributed in pre-defined configurations within the body portion, such as around the periphery of the body portion, or in groups at one or more locations within the body. In some embodiments the body portion has a circular, elliptical, regular polygonal or semi-circular cross-section. The body portion may be shaped in the form of a cylinder, a rope, a filament, a strip, a ribbon or the like, or may be shaped in the form of a standard confectionery product such a chocolate bar, or chewing gum slab, pellet, ball, stick or ribbon, for example. The body portion may be irregular or regular in shape. Furthermore, the body portion may be formed in potentially any shape, for example in the shape of an object, cartoon character or an animal to name a few.

Two or more capillaries may have different widths or diameters. Such an arrangement will allow, if desired, for different quantities of different fill materials to be incorporated into different capillaries. Furthermore, the two or more capillaries may have different cross-sectional profiles. For example, the confectionery product may have capillaries having cross-sectional shapes including stars and triangles, or different shapes of animals etc.

In an embodiment, the capillaries in the body portion result in a voidage in the range of 1-99% of the extrudate, or in the range of 5-99% of the extrudate. The voidage may be in the range of 10-60%, 20-50%, 30-45%, or 35-40%. The voidage may also be in intermediate points in these ranges, for example, 5-40%, 5-45%, 5-50%, 5-60%, 10-40%, 10-45%, 10-50%, 10-99%, 20-60%, 20-45%, 20-40%, 20-60%, 20-99%, 30-40%, 30-50%, 30-60% or 30-99%. The voidage may be up to 99%, 95%, 90%, 80%, 60%, 50%, 45%, 35%, 30%, 20%, 10%, or 5%. The voidage may be over 5%, 10%, 15%, 20%, 25%, 30%, 35%, 40%, 45%, 50%, 55%, 60%, 65%, 70%, 75%, 80%, 85%, 90% or 95%.

The incorporation of capillaries of a small cross-sectional width or diameter enables the capillaries to entrain contrasting or complementary confectionery materials into the body portion whilst avoiding the need to incorporate large centre-fill areas which may be prone to leakage through, or out of, the confectionery product. The use of a plurality of capillaries also enables two or more materials to be incorporated into the confectionery product to give multiple textures, tastes, colours, mouth-feel sensations, temporal profiles and/or sensorial profiles throughout the whole confectionery product.

In some embodiments, the capillaries have a diameter or width of no more than, 2 mm, 1 mm, 0.5 mm, 0.25 mm or less. It is possible to have capillaries having a diameter or width of no more than 100 μm, 50 μm or 10 μm.

The confectionery product may comprise a first extruded portion and a second extruded portion, wherein each portion has a plurality of capillaries disposed therein, and the capillaries of the first and second portions are:
a) discontinuous; and/or
b) continuous and oriented in more than one direction.

The capillaries of each portion may be formed substantially parallel to one another. In one embodiment, the first and second portions are in a stacked configuration, such that the capillaries of the first and second portions are substantially parallel to each other. In an alternative embodiment, the first and second portions are in a folded configuration. In yet another alternative embodiment, the first and second portions are discontinuous and the capillaries are oriented in a random, symmetric or asymmetric configuration or position in relation to one another. For example, a product may include two or more symmetrically positioned capillaries and two or more asymmetrically positioned capillaries. Distances between the capillaries may not always be consistent or equal. In some embodiments, the capillaries of the first and/or second portions have a diameter or width of no more than, 3 mm, 2 mm, 1 mm, 0.5 mm, 0.25 mm or less. It is possible to have capillaries having a diameter or width as low as 100 μm, 50 μm or 10 μm. The capillaries of the first and/or second portions may have different widths or diameters.

There may be further portions in addition to the first and second portions, which may or may not comprise capillaries. In one embodiment, the confectionery product comprises the first portion separated from the second portion by one or more further portions that may or may not contain capillaries.

The first and second portions may be as described hereinabove for the body portion. The first and second portions may comprise the same material or different materials. For example, the first portion may be chocolate and the second portion candy. The capillaries in each of the first and second portions may be filled with the same or different materials. One or more capillaries in the first and/or second portions may be filled with different material(s) to other capillaries in the first and/or second portion.

According to a further embodiment of the invention, there is provided a confectionery product comprising an extruded body portion having a plurality of capillaries disposed therein, wherein each capillary is separated from each adjacent capillary by a wall formed from the extruded body portion and wherein the wall between each capillary has a thickness of no more than the width or diameter of the capillaries.

According to a yet another embodiment of the present invention, there is provided a confectionery product comprising an extruded body portion, the body portion having a plurality of capillaries disposed therein, the capillaries having a width or diameter of less than 0.2 mm.

According to a yet another embodiment of the present invention, there is provided a confectionery product comprising an extruded body portion, the body portion having a plurality of capillaries disposed therein, the capillaries in the body portion resulting in a voidage in the range of 5-99% of the extrudate.

According to further embodiment of the present invention, there is provided a confectionery product including an extruded body portion and a plurality of capillaries disposed in the extruded body portion, wherein the body portion includes a combination of confectionery compositions, e.g., hard candy and chewing gum, hard candy and chewy candy or chewy candy and chewing gum, and wherein the product further includes a center-fill region. The capillaries may be distributed around the periphery of the body portion and surrounding the center-fill region. In some embodiments, the center-fill region includes a fill material selected from liquids, semi-solids, solids and combinations thereof. In some embodiments of the present invention, the plurality of capillaries disposed in the body portion of the confectionery product may be anywhere from 2-50 capillaries, from 5-50 capillaries, from 10-40 capillaries, from 20-40 capillaries or from 30-40 capillaries. The capillaries may result in a voidage in the range of about 5-40%, or about 10-40%, or about 20-40%, or about 30-40%, of the extrudate. The capillaries may have an average diameter or width of about 0.1-5 mm. In some embodiments, such as some embodiments that do not employ further stretching of the extrudate, the average diameter or width of the capillaries may be, for instance, about 0.5-5 mm. In some other embodiments, such as some embodiments employing further stretching of the extrudate, the average diameter or width of the capillaries may be reduced, for instance, to about 0.1-1 mm.

In some embodiments, the wall or separation between each capillary may have a thickness of about 0.1-3 mm. In some embodiments, such as some embodiments that do not employ further stretching of the extrudate, the wall between each capillary may have a thickness of about 0.5-3 mm. In some other embodiments, such as some embodiments employing further stretching of the extrudate, the wall between each capillary may be reduced to a thickness of about 0.1-2.5 mm, or about 0.1-1 mm in some embodiments.

In some embodiments, the plurality of capillaries may be centrally grouped within the extruded body portion and surrounded by an outer wall that extends to the outer surface of the body portion. In such embodiments, the outer wall may have a thickness of about 0.1-5 mm. In some embodiments, such as some embodiments that do not employ further stretching of the extrudate, the outer wall may have a thickness of about 0.5-5 mm. In some other embodiments, such as some embodiments employing further stretching of the extrudate, the outer wall may be reduced to a thickness of about 0.1-1 mm.

In addition, in some embodiments, the final piece weight of the individual confectionery products formed from the extrudate may be about 1-10 g and the cross-sectional size may be anywhere from about 5-30 mm, for instance, a circular to cross-section having a diameter of about 10-30 mm.

The skilled addressee will of course realise that these subsequent embodiments may incorporate features which have already been discussed with reference to the initial embodiment.

According to a further embodiment, there is provided a process for manufacturing a confectionery product comprising a body portion, having a plurality of capillaries disposed therein, the process comprising the step of:
a) extruding an extrudable confectionery material which is liquid during extrusion with a plurality of capillaries disposed therein, wherein the capillaries have a width or diameter of no more than 3 mm.

In some embodiments, the method may include an extra step selected from:
b) cutting the extrudate into two or more pieces having a plurality of capillaries disposed therein and forming a confectionery product incorporating the pieces; and/or
c) folding the extrudate and forming a confectionery product incorporating the folded extrudate.

In accordance with another embodiment of the present invention, there is provided a process for manufacturing a confectionery product including an extruded body portion having a plurality of capillaries disposed therein, the process including the steps of:
a) extruding an extrudable confectionery material with a plurality of capillaries disposed therein, the extrudable confectionery material including a hard candy composition and a chewing gum composition; and
b) at least partially filling one or more of the capillaries with a fill material.

In another embodiment, there is provided a process for manufacturing a confectionery product including an extruded body portion having a plurality of capillaries disposed therein, the process including the steps of:
a) extruding an extrudable confectionery material with a plurality of capillaries disposed therein, the extrudable confectionery material including a chewy candy composition and a chewing gum composition; and
b) at least partially filling one or more of the capillaries with a fill material.

In yet another embodiment, there is provided a process for manufacturing a confectionery product including an extruded body portion having a plurality of capillaries disposed therein, the process including the steps of:
a) extruding an extrudable confectionery material with a plurality of capillaries disposed therein, the extrudable confectionery material including a chewy candy composition and a hard candy composition; and
b) at least partially filling one or more of the capillaries with a fill material.

In some embodiments, the processes may include an extra step selected from:
c) cutting the extrudate into two or more pieces having a plurality of capillaries disposed therein and forming a confectionery product incorporating the pieces; and/or
d) folding the extrudate and forming a confectionery product incorporating the folded extrudate.

Any of the above processes may further comprise the step of depositing a filling in at least part of one or more of the capillaries. The deposition of the filling may be during the step of extrusion—but could also take place after extrusion. In an embodiment, the filling comprises a fluid. The fluid may comprises a liquid, or a material which is liquid at a temperature greater than room temperature. The fluid may solidify after deposition if desired.

Any of the processes may further comprise the step of quench cooling the extrudate after extrusion. The quench cooling may utilise a fluid, such as air, an oil or liquid nitrogen—but other methods of quench cooling will also be apparent to the skilled addressee.

Any of the processes may further comprise the step of, after extrusion, stretching the extrudate. Stretching the extrudate may be undertaken by a number of means, for example passing the extrudate over, or through conveyor belts or rollers operating at different speeds, so as to stretch the extrudate. By employing this additional step, extrusions having capillaries of a larger diameter, width, cross-sectional area, etc. can be undertaken, which can be reduced in size gradually over time so as to produce an extrudate with smaller capillaries which would have been more difficult to produce. Commonly, capillaries having a bore size of 2 mm or more will be produced during extrusion and these capillaries will be reduced significantly by stretching the extrudate. In some embodiments the capillaries are reduced to no more than 1 mm, 0.5 mm, 0.25 mm, 100 μm, 50 μm, 25 μm or 10 μm.

Any of the processes may further comprise the step of enveloping the confectionery product in a coating. Such a coating will be apparent to the skilled addressee and discussed previously.

The extrudable confectionery material will at least partially or substantially solidify after extrusion.

If desired, two or more capillaries may be formed having different widths or diameters. Furthermore, two or more of the capillaries may be formed having different cross-sectional profiles.

The processes may be used for producing a confectionery material as herein above described.

A further embodiment of the present invention provides for apparatus which is adapted for producing a confectionery product according to the processes as herein above described. WO2005056272 discloses an apparatus for producing an extrudated product including a plurality of channels. WO2008044122 discloses a related apparatus, which additionally includes means for quench cooling an extrudate as it exits the die. Both of these apparatus may be employed/adapted for use in producing the confectionery in accordance with the present invention.

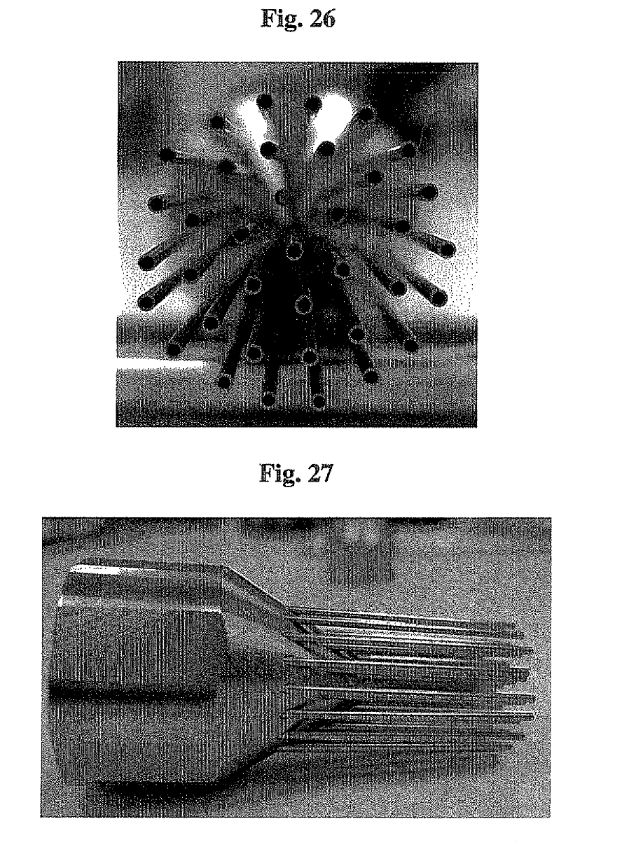

The extrusion die employed in the apparatus can be a ribbon die, matrix die, annular die or circular die. Different dies can be used to produce different extruded product shapes and different amounts and patterns of the capillaries. In particular, different dies can have different numbers of needles, thereby providing extruded products with different amounts of capillaries disposed therein. The needles also may have different cross-sectional profiles, thereby providing extruded products with various shapes and patterns of the capillaries. For instance, in some embodiments, a die may have anywhere from 2-50 needles. In some embodiments, the die may have a smaller number of needles, such as for instance 3-5 needles. In some other embodiments, the die may have a larger number of needles, such as for instance 20-40 needles, or 30-40 needles in some embodiments. For example, the matrix die shown in FIG. 25 contains 30 needles having an inner diameter of 0.5 mm. The circular die shown in FIGS. 26-27 contains 37 needles having an inner diameter of 1.1 mm.

In addition, the apparatus can include a flange surrounding the die and defining the orifice of the extrusion apparatus. Different flanges can be employed to form different outer shapes of the extrudate. The flange also can define the distance between the plurality of capillaries and the outer surface of the extrudate. For instance, the plurality of capillaries may be centrally grouped within the extruded body portion and surrounded by an outer wall that extends to the outer surface of the body portion. The thickness of the outer wall can be determined by the size of the flange.

In some embodiments, the extrusion die may include a rotary valve that is adapted to rotate to create swirl-type patterns of capillaries within the body portion. For instance, in one embodiment, the capillaries may swirl around a center-fill region of the product. An example of a rotary valve, which could be employed/adapted for use herein, is disclosed in International Publication No. WO2008048881A2, which is incorporated by reference herein.

### DETAILED DESCRIPTION OF THE INVENTION

Specific embodiments of the present invention will now be described, by way of example only, with reference to the accompanying drawings, in which:

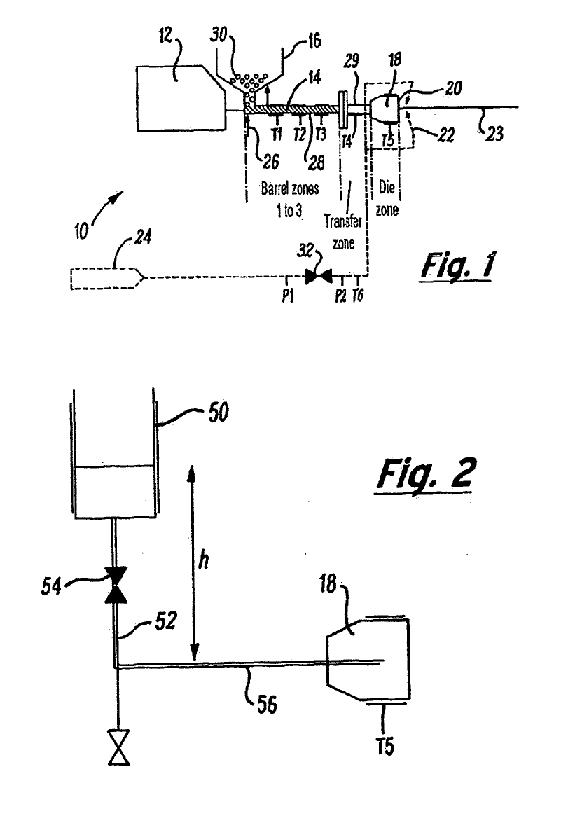

FIG. 1 is a schematic diagram illustrating the overall apparatus used for the experiments described in Examples 1 and 2, in accordance with the present invention;

FIG. 2 is a schematic diagram illustrating the apparatus which can be used in conjunction with the apparatus shown in FIG. 1, so as to provide a liquid filled capillaries;

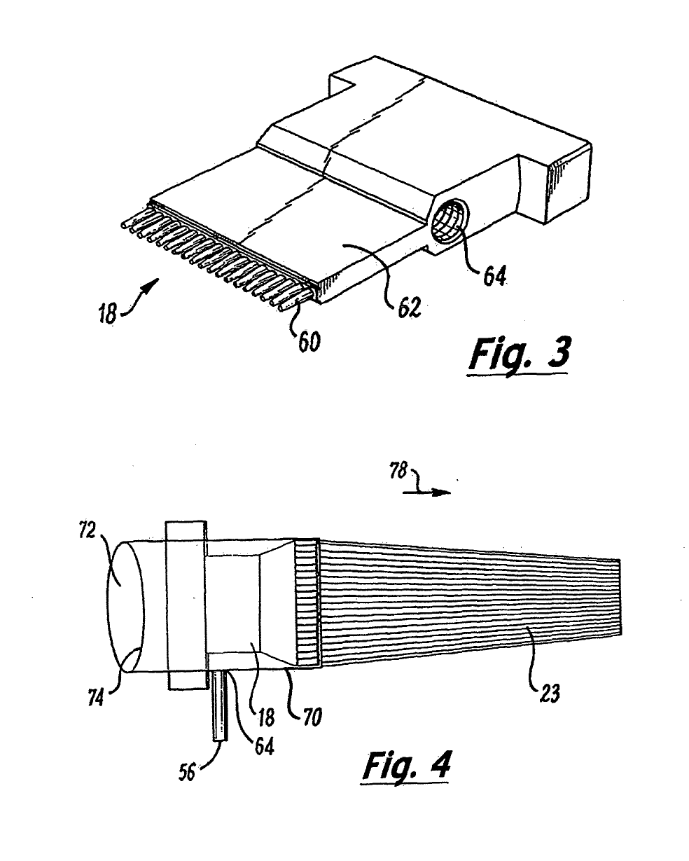

FIG. 3 is a photograph of the extrusion die used to form capillaries in the extruded material of Examples 1 and 2;

FIG. 4 is a plan view of the extrusion die which incorporates the extrusion die shown in FIG. 3 in the apparatus as illustrated in FIGS. 1 and 2;

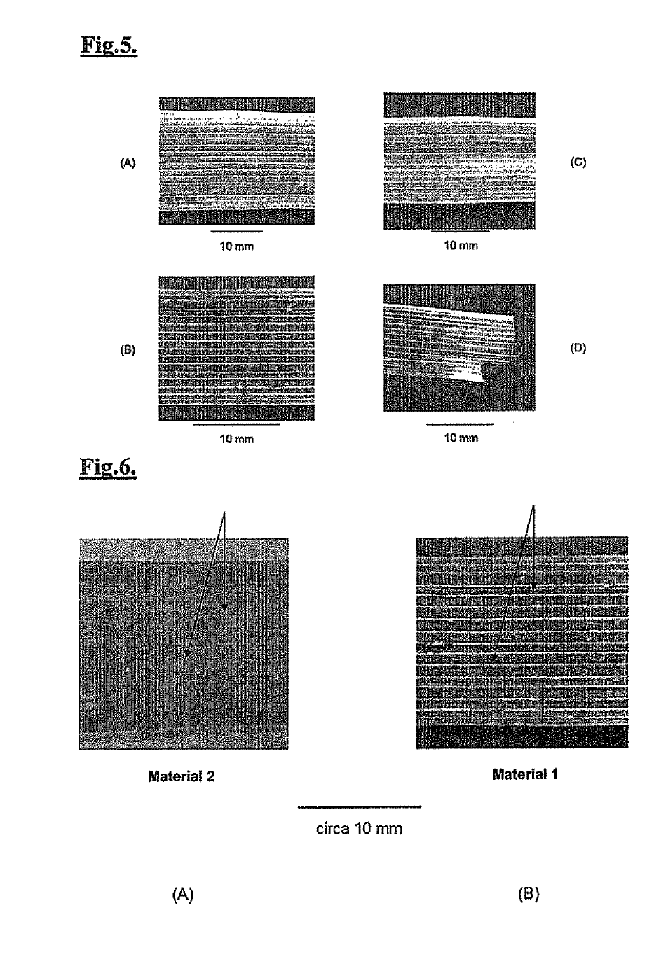

FIG. 5 shows photographs of four capillary extrudates formed from material 1 in Example 1, the photographs show: (A) low voidage, (B) and (C) high voidage and (D) very high voidage;

FIG. 6 shows photographs comparing capillary extrudates formed from (A) material 2 containing completely filled cocoa butter capillaries and (B) material 1 formed with air filled capillaries;

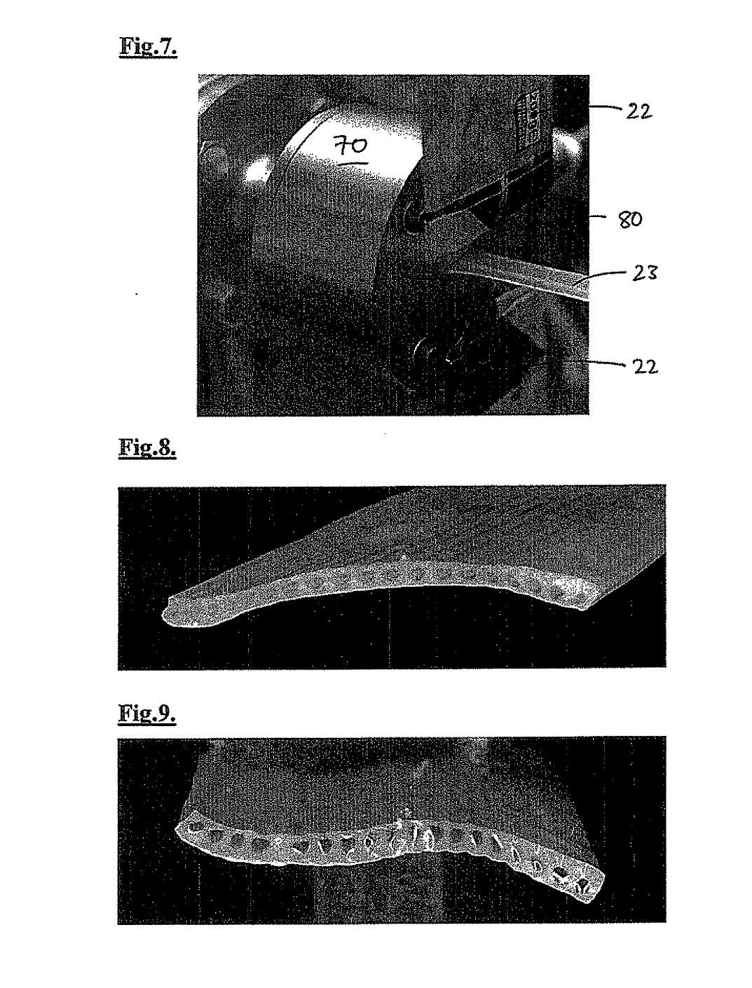

FIG. 7 shows a photograph of the external part of the extrusion apparatus as illustrated in FIGS. 1 and 2, showing the air knives used to cool the extrudate when it exist the die;

FIG. 8 shows a hard candy with an air fill produced in Example 2, in accordance with the present invention;

FIG. 9 shows a hard candy with a liquid fill produced in Example 2, in accordance with the present invention;

FIG. 10 shows a gum with an air fill, produced in Example 2, in accordance with the present invention;

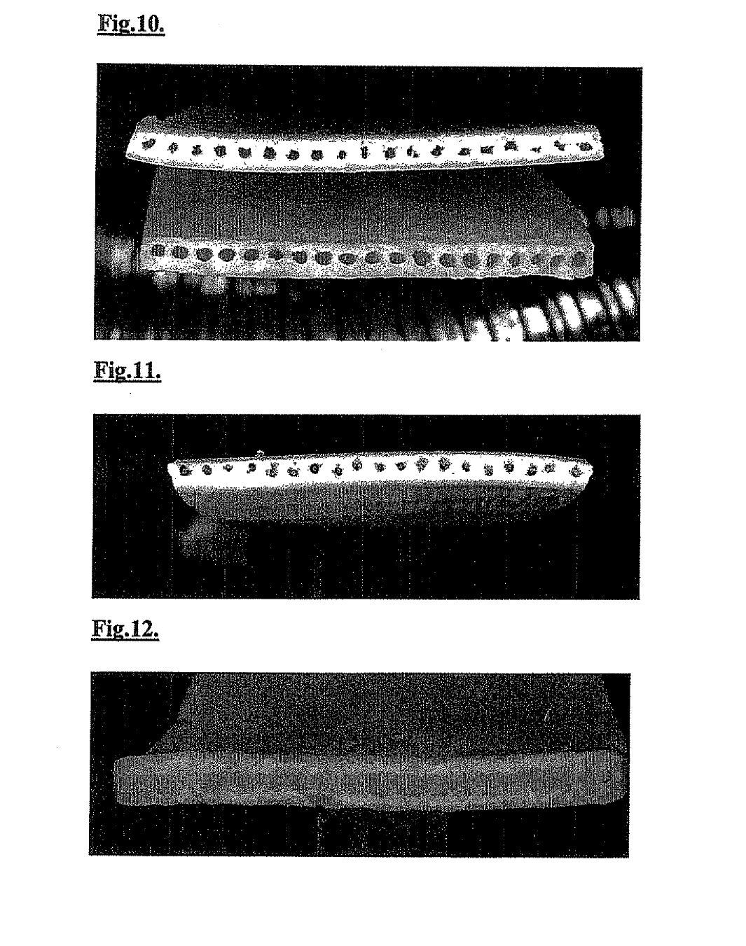

FIG. 11 shows a gum with a liquid fill, produced in Example 2, in accordance with the present invention;

FIG. 12 shows a gum with a solid fill, produced in Example 2, in accordance with the present invention;

FIG. 13 shows a chocolate with an air fill, produced in Example 2, in accordance with the present invention;

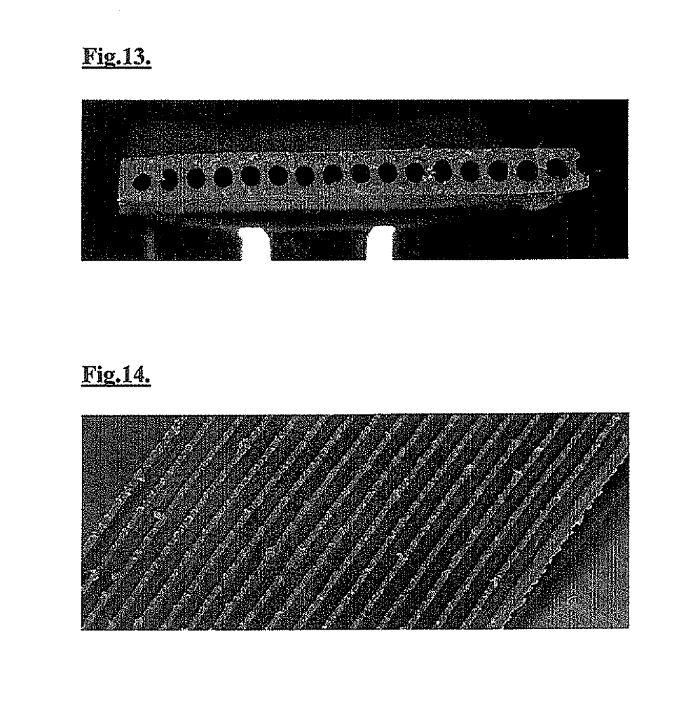

FIG. 14 shows a chocolate with an air fill as shown in FIG. 13, but in longitudinal cross section;

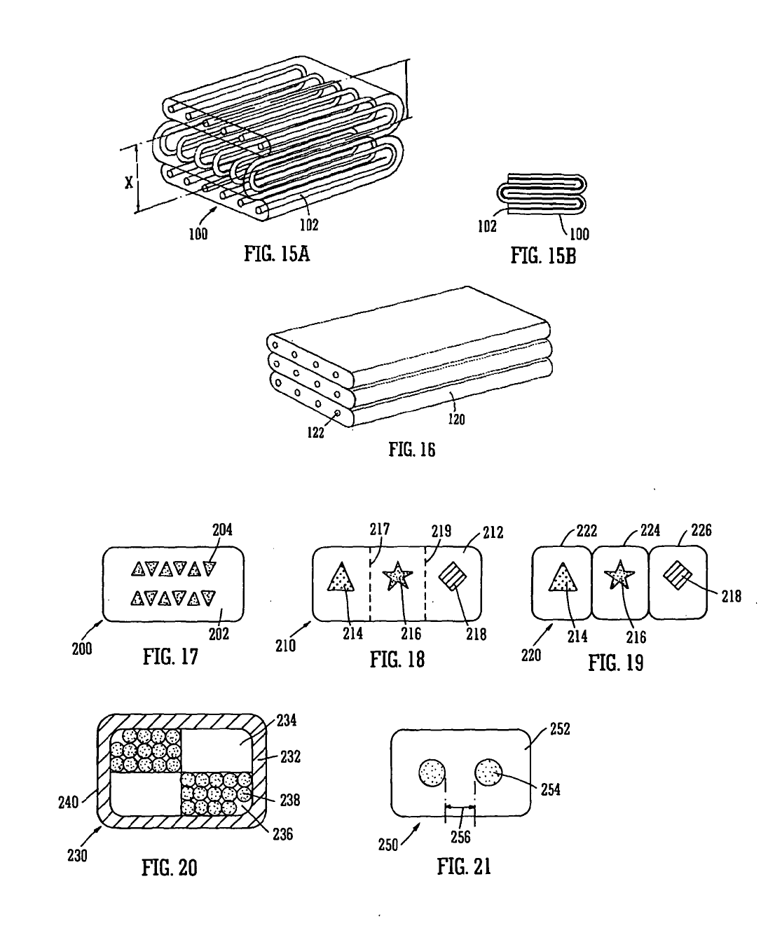

FIG. 15A shows a perspective view of an extrudate formed in accordance with the present invention, where the extrudate has been folded;

FIG. 15B shows a cross-sectional view of the extrudate as shown in FIG. 15A, viewed from the line denoted “X”;

FIG. 16 shows a perspective view of an extrudate formed in accordance with the present invention, where a number of extrudated layers have been stacked upon one another;

FIG. 17 shows a schematic cross-section of a confectionery product in accordance with the present invention, where the capillaries are of a uniform cross-sectional shape and arranged in a uniform manner;

FIG. 18 shows a schematic cross-section of a confectionery product in accordance with the present invention, where the capillaries are formed having different cross-sectional shapes;

FIG. 19 shows a similar schematic cross-section of a confectionery product similar to that shown in FIG. 18, however the confectionery product is formed of three different portions.

FIG. 20 shows a schematic cross-section of a confectionery product in accordance with the present invention, where the capillaries are arranged in a uniform manner in particular areas of the confectionery product;

FIG. 21 shows a schematic cross-section of a confectionery product in accordance with the present invention, where each capillary is separated from each adjacent capillary by a wall formed from the extruded body portion and the wall between each capillary has a thickness of no more than the width or diameter of the capillaries;

FIG. 22 shows a photograph of the cross-section of a confectionery product with an air fill produced in Example 3, in accordance with the present invention;

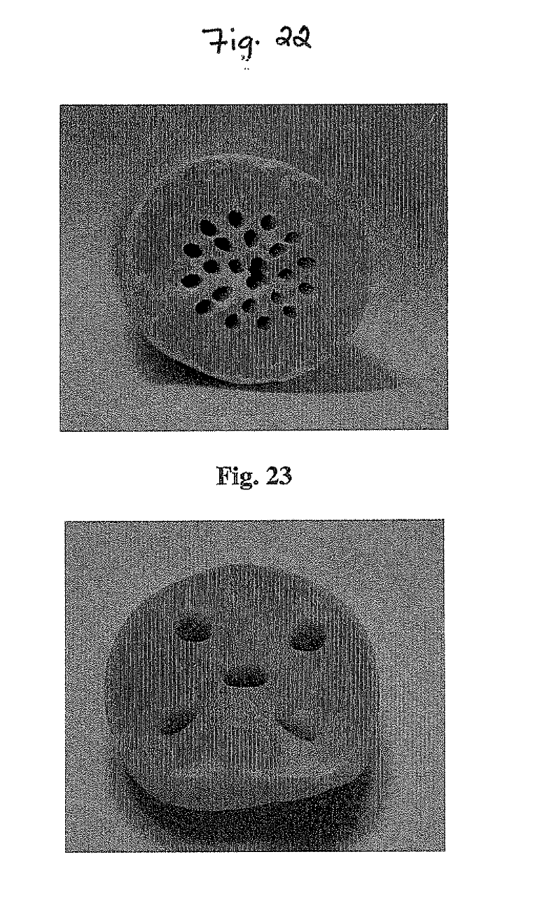

FIG. 23 shows a photograph of the cross-section of another confectionery product with an air fill produced in Example 3, in accordance with the present invention;

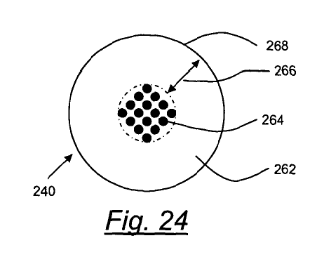

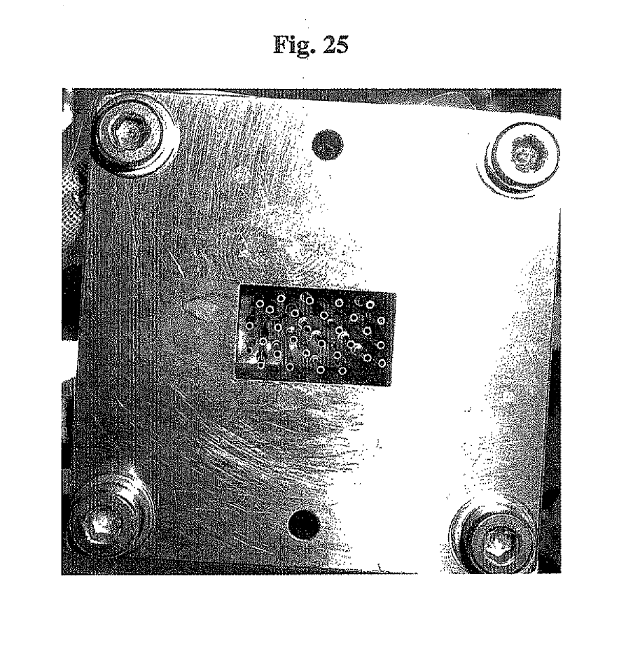

FIG. 24 shows a schematic cross-section of a confectionery product in accordance with the present invention, where the extruded body portion includes a mixture of a hard candy composition and a chewing gum composition and a plurality of capillaries disposed therein, the capillaries being centrally grouped within the body portion and surrounded by an outer wall extending to the outer surface of the body portion;

FIG. 25 is a photograph of a matrix extrusion die that can be used to form capillaries in extruded materials in accordance with some embodiments of the present invention;

FIG. 26 is a photograph of a circular extrusion die that can be used to form capillaries in extruded materials in accordance with some embodiments of the present invention; and

FIG. 27 is a photograph of a different view of the circular extrusion die shown in the photograph of FIG. 26.

Experiments were conducted to produce a variety of confectionery products incorporating capillaries. Three phases of extrusion work were undertaken using various materials. The first phase concerned the extrusion of hard candy using a capillary die attached to a small-scale extruder in a non-food grade environment for creating capillary candy extrudates in both low- and high-voidage forms. The second phase of the experimental work built upon the first phase to produce low and high voidage candy capillary extrudates containing an array of cocoa-butter filled capillaries. The first and second phases are described below in Example 1, The third phase built upon the first two and recreated the working environment with food grade equipment in a food grade environment and is described below in Example 2.

### Example 1

Phase one concerned the extrusion of candy using a capillary die attached to a small-scale extruder, in order to confirm that candy having capillaries with both low and high voidage values could be formed in accordance with the present invention.

The materials that were trialled during this investigation are shown in Table 1.

TABLE 1
Materials tested.

| Material | | | |
|---|---|---|---|
| number | Material name | Majority ingredients | Application |
| 1 | Custom recipe 1 | Sugar (40%) Glucose | Extruded matrix |
| | | Syrup (60%) | |
| 2 | Custom recipe 2 | Maltitol syrup (96%) | Extruded matrix |
| | | Gum Arabic (2%) | |
| | | Water (2%) | |
| 3 | Cocoa butter | Cocoa butter (100%) | Capillary filler |

Materials 1 and 2 were supplied as large solid blocks. All materials were crushed prior to extrusion to yield a fine granular powder, with grain sizes ranging between 1 mm and 5 mm. Material 3 was supplied as a tub of solidified cocoa butter; the required quantity was broken up into a fine powder containing only small lumps before being fed into the heated cocoa butter reservoir. The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using PID controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired, the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled. In use, the hopper 16 is filled with material 30 (such as candy in solution) which can be heated so as to render it (or maintain it as) a liquid (not solid or solid particulate form). Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature adjusted again (if required) by temperature control to T4 before entering the die 18. The die 18 (shown in FIG. 3) has a number of needles (not shown) located within an entrainment body so that the material passes over and around the needles. At the same time that the material is being extruded, compressed air 24 is forced through the needles so that the extrudate contains a number of capillaries. The extrudate 23 is cooled by means of the quench jets 22 as it is released from the die 18. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through needles, the needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the capillaries formed around and the needles can be simultaneously filled with cocoa butter. Of course, the capillaries could be filled with other types of liquid material if desired.

FIG. 3 shows the die 18 in more detail. In particular, this figure shows that the metallic die 18 has, at one end, a plurality of needles 60 which are joined to a cavity 62 which is in fluid communication with an inlet channel 64 for pumping a fluid material into the capillaries of the extrusion.

In some alternative embodiments of the present invention, the die employed in the apparatus can be a matrix die, annular die or circular die instead of the ribbon die used in this experiment. Different dies can be used to produce different extruded product shapes and different amounts and designs of the capillaries. FIG. 25 shows a matrix die suitable for use in some embodiments of the present invention. The matrix die shown in FIG. 25 contains 30 needles having a diameter of 0.5 mm. FIGS. 26-27 show a circular die suitable for use in some embodiments of the present invention. The circular die shown in FIGS. 26-27 contains 37 needles having a diameter of 1.1 mm.

With reference to FIG. 4, there is shown the die 18 in place in an entrainment body 70. Molten material 72 enters an opening 74 of the entrainment body 70 and the material is forced over and around the needles 60 of the die 18. At the same time, either air or liquid cocoa butter enters the die inlet by means of a fluid feed conduit 56. When operational, the molten material is extruded through the entrainment body 70 over the needles 60 of the die 18. Either air or cocoa butter is then pumped through the needles at the same time so as to produce an extrudate 23 (in direction 78) which either has capillaries with no filling or capillaries filled with cocoa butter.

FIG. 7 shows the entrainment body 70 having an opening 80, through which the extrudate is formed. This figure also shows two quench jets 22 located above and below the aperture so as to cool down the extrudate after is has been produced.

In use, the flow of molten material over the tips of the entrainment nozzles (hypodermic needles) caused a small area of low pressure to form at each needle tip. Each nozzle was connected together via internal channelling within the entrainment body. These, in turn, were connected outside the extrusion die to either air at room temperature and pressure or to a molten cocoa butter reservoir, with a hydraulic head of h in FIG. 2. The pipework connecting the die to the cocoa butter reservoir and the cocoa butter reservoir was externally heated to maintain the cocoa butter in the liquid phase. A set of isolation valves were used to switch between either using an air feed to the entrainment body or a molten cocoa butter feed. This is shown schematically in FIG. 2.

The quench jets were used for the generation of the high-voidage material. Differential scanning calorimetry (DSC) was used to examine the thermal behaviour of the materials, such that information relating to the phase transition temperatures could be obtained.

Material 1 was formed in a large solid block. The block was broken up mechanically, such that it became a granulated material with granule sizes between 1 mm and 5 mm.

The extrusion temperature profile was set to that shown in below Table 2.

TABLE 2
Extruder temperature profile for material 1.

| Temperature zone | Label on FIG. 1 |
|---|---|
| Barrel zone 1 | T1 |
| Barrel zone 2 | T2 |
| Barrel zone 3 | T3 |
| Die zone 1 | T4 |
| Die | T5 |

Granulated pieces of material 1 were starve-fed into the extruder, with the extruder screw-speed set to 40 rpm. The granules of material 2 conveyed well into the extruder in the solid phase initially, but due to the sticky nature of the material, some mild feed zone bridging and blocking was observed. This was overcome by gently pushing the broken-up material onto the extruder screw with a polyethylene rod.

Successful capillary extrudates were easily achievable using this protocol. The material had good melt strength and was pulled away easily from the die in the molten state before it set into a brittle, glassy, material. The glassy state of the material meant that it was unsuitable for use in a pair of nip rolls since the compression experienced by the material in this apparatus caused fracture. Consequently, the capillary extrudates from material 1 were hand drawn, the capillaries having an average diameter (width) of less than 4 mm.

Low voidage MCF from material 1 was easily obtained without quenching the extrudate using the quench jets; this is illustrated in the photograph in FIG. 5(A). Enhanced manual hauling of the extrudate away from the die exit coupled with use of the quench jets resulted in high voidage capillary being extruded. The ultimate voidage depended on the speed at which material is hauled away from the die; various different forms of high voidage capillary extrudate formed from material 1 are shown in FIGS. 5(B), (C) and (D). Crude optical analysis of the cross section of material similar to those shown in FIGS. 10 (B) and (C) revealed that voidage between 35% and 40% had been generated. It is highly likely that the high voidage material shown in FIG. 10 (D) was in excess of the value of 35% or 40%.

The second phase of the of extrusion experiments were conducted with material 1 using cocoa butter heated to between 35° C. and 40° C. The head, h, of the cocoa butter reservoir was initially set to 8 cm, and material two fed into the extruder as described earlier. The initial proof of concept was successful, and resulted in the partial filling of the capillaries with molten cocoa butter. It was observed, however, that due to the increased viscosity of the cocoa butter compared to air, the rate at which cocoa butter could be entrained into the extrudate was slow. This problem appeared to be solved by increasing the head of the reservoir to 21.5 cm. It was also observed qualitatively that, in low voidage form, the cocoa-butter filled capillaries appeared somewhat smaller than their air-filled counterparts (less than 3 mm compared to less than 4 mm). It was also possible to create high-voidage cocoa-butter filled capillary extrudates, subject to the coca-butter head being high enough to supply molten cocoa butter at the increased rate.

Material 1 was successfully formed into capillary extrudates, of both high and low voidage, with either airfilled capillaries or cocoa butter-filled capillaries. Varying different voidages films were made, and it was observed that increasing levels of voidage led to increasing fragility. A representative figure for one of the high voidage air-cored films was between 35% and 40% and it is estimated that the very high voidage, highly fragile films, exceeded this.

Material 2 was formed from a mixture of 96% maltitol syrup, 2% gum Arabic, 2% water. Material 2 was shown to act in a similar manner to material 1, in that it was supplied in a large block that was required to be broken up mechanically into smaller granules before it could be fed into the extrusion line. Prior to extrusion experiments commencing, the extrusion die was disassembled and washed and the extruder was fed a hot water wash to dissolve any material 1 remaining within the extruder barrels or on the screw. After the water was purged from the extruder, the extruder was heated to 130° C. for between five and ten minutes to evaporate any remaining water. An early scoping experiment revealed that material 2 required higher extrusion temperatures than material 1; the final extrusion line temperature profile is shown in Table 3 below.

TABLE 3
Extruder temperature profile for material 2.

| Temperature zone | Label on FIG. 1 | Temperature (° C.) |
|---|---|---|
| Barrel zone 1 | T1 | 115 |
| Barrel zone 2 | T2 | 115 |
| Barrel zone 3 | T3 | 115 |
| Die zone 1 | T4 | 115 |
| Die | T5 | 120 |

As with material 1, material 2 was starve-fed into the extruder. As with material 1, the screw speed was set to 40 rpm. Material 2 proved to be easy to extrude and capillary extrudates with air-filled capillaries were produced in both low and high voidage forms. Material 2 exhibited good melt strength, good drawing characteristics prior to solidifying and became brittle and glassy upon solidification. Again, this precluded the use of nip rollers to draw the material from the die and control the amount of draw down achieved, hence manual drawing was used in a similar way to material 1. In terms of restarting the extrusion line after an idle period, material 2 did not prove to be noticeably different to material 1, and the line restarted relatively easily. Due to the ease with which capillary extrudates were achieved, phase one was concluded relatively quickly to allow progression to phase two.

Phase two experiments were conducted with material 2 using cocoa butter heated to between 35° C. and 40° C. The head, h, of the cocoa butter reservoir was kept at 21.5 cm, and material 2 starve-fed into the extruder as described in the previous section. Successful extrusion of both low- and high-voidage micro capillary extrudate from material 2 containing completely filled cocoa-butter capillaries was achieved. A photograph comparing the cocoa-butter filled capillaries of material 2 to the air filled capillaries of material 1 is shown in FIG. 6. Crude optical analysis of a cross section of a piece of high-voidage material 2 revealed that the voidage was roughly 35% at minimum. It is likely this figure can be easily increased through optimisation of the protocol.

The observations for material 2 are similar to those from material 1. Low- and high-voidage capillary extrudates were formed, either containing cocoa-butter capillaries or air-filled capillaries. Crude optical analysis of a moderately high-voidage extrudate revealed that the void fraction was approximately 35%. Although, it is thought that the actual figure may have been higher. Increasing product voidage again led to increasing product fragility due to the capillary walls becoming very thin.

The objective of these first and second phase experiments were to provide proof-of-concept for the extrusion of capillary extridates from various candy materials. This was successful with both materials (material 1=40% sugar and 60% glucose, and material 2=96% maltitol syrup, 2% gum Arabic and 2% water). Low- and high-voidage capillary extrudates were formed containing both air-filled capillaries and cocoa-butter filled capillaries. It was estimated that a typical high-voidage extrudate contained roughly 35% to 40% voidage whether it was air filled or cocoa-butter filled.

### Example 2

The third phase built upon the first two phases described in Example 1 and recreated the working environment with food grade equipment in a food grade environment. This food-grade setup extruded hard candy, chocolate and chewing gum with air, liquid and solid centres. This range of filled extrudates were made in a food grade environment and were consumed to investigate their edible properties.

The following edible materials were used in these experiments:

Chewing gum (uncoated Peppermint-Spearmint Higher flavour chewing gum pellets); hard candy, mint candy (Extra Strong Mints®, Jakemans® Old Favourites), fruit candy (Summer Fruits, Jakemans® Old Favourites), chocolate (milk chocolate (with 0, ½, 1, 2% added water), Cadbury® Dairy Milk® Buttons—when used molten, 2% PGPR was added to lower the melt viscosity for ease of use (c.f. legal limit of ½%)), compound chocolate (Plain Belgian Chocolate, SuperCook®), 72% Cook's Chocolate, Green & Black's®. Liquid fillings used in these experiments included: monopropylene glycol (Propane-1,2-diol, BP, EP, USP, Fisher Scientific®—selected for low viscosity, zero moisture, low flavour, and BP, EP & USP grade for oral use), Golden Syrup (partially inverted refiners syrup—Tate & Lyle®-selected for higher viscosity, food grade, shelf stability, and sweet flavour), Red Food Colouring (SuperCook®, UK), Blue Food Colouring (SuperCook®, UK). Lastly, a solid filling of cocoa butter obtained internally from a Cadbury Plc. site was also used in these experiments and this was selected because it is solid at room temperature and has low hot viscosity.

A Davis-Standard HPE-075 ¾″ 24:1 single-screw extruder was used in these experiments. The extruder also included air-knives and a header tank. The screw was a simple conveying-compression-pumping all forward element design, with no mixing or reversing sections. The motor was 3 KW, geared to produce 0-100 rpm screw rotation. The feed throat was jacketed and supplied with flowing ambient water to prevent heat transfer from the barrel causing feed problems with sticky feedstuff. The barrel had three heating zones, each with a 1 KW heater and forced ambient air cooler. The standard extruder has a Eurotherm 3216 controller per barrel zone and one spare for the die (die controller connected to thermocouple input and standard 16 A 240 v socket for up to 1 KW heater output).

At point of purchase, two additional die controllers, thermocouple inputs and heater outputs were specified to enable integrated control of the header tank containing filling material and the pipework connecting that header tank to the die. The die was an assembly of parts comprising a body with main die orifice of long thin rectangular shape, through which 19 interconnected nozzles (similar in size to hypodermic needles) also exited. The main body was heated and the nozzles led to an external fitting that could be opened to ambient air or could be connected to the heated, pressurized header tank. A bobbin shaped flange was constructed to mount the die assembly onto the extruder end flange.

The die was heated with 4×100 W ¼″ cartridge heaters, and monitored by a K-type thermocouple probe. Initially these were controlled by a Eurotherm 3216 in a bespoke enclosure until the control and power wiring was transferred to a Eurotherm integrated into the extruder. The die assembly was earthed into the power outlet from the extruder.

The header-tank and the pipework connecting the header tank to the die were heated with two 100 W ribbon heaters initially controlled from a single analogue controller in a bespoke enclosure, and monitored by a single bare K-type thermocouple. These were later separated to two Eurotherm 3216 s integrated into the extruder with two thermocouples and two power supplies. The header tank was earthed to the power outlet, whilst the pipework was plastic and did not need to be earthed.

Compressed air, BOC®, UK was regulated with series 8000 gas regulator and pressures used were 0-100 bar. The main use for the compressed air was to supply the air-knives.

Food Safe High-Tech Grease, and Food Safe Penetrating Oil from Solent Lubricants, Leicester, UK was used.

The capillary die was connected on the extruder endplate. Two opposed air knives were used to rapidly quench the extrudate emerging from the extrusion die, were placed above and below the die exit; these jets were connected via a valve to a compressed air line at 10 bar pressure. A schematic diagram showing the general layout of the extrusion line is shown in FIG. 1.

In use, the flow of molten material over the tips of the entrainment nozzles (hypodermic needles) caused a small area of low pressure to form at each needle tip. Each nozzle was connected together via internal channelling within the entrainment body. This, in turn, was connected outside the extrusion die to either air at room temperature and pressure or to a header tank containing a liquid that was at ambient or elevated temperature and pressure, with a hydraulic head of h. The header tank and the pipework connecting to the die were externally heated. A set of isolation valves were used to switch between either using an air feed to the entrainment body or a molten cocoa butter feed. This is shown schematically in FIG. 2.

The quench jets were used for the generation of the high-voidage material. It had been found during previous research that if the emerging extrudate was quenched very rapidly and subjected to a high drawing force, a higher voidage cross section could be obtained. Adjustment of the polymer and process conditions yielded voidages up to, and possibly in excess of, 60%.

Hard candy was pre-broken before introduction to the extruder. Particle size was not important—the extruder was found to take whole candies or dust. It was found that broken candies fed more evenly than whole pieces. All barrels and the die were set to 95° C. for fruit candy. Mint candy had tolerance to a wide range of temperatures and could run with barrels and die at 95°-110° C.

Screw speeds of 15-100 rpm were used in the experiments. Differences in product were minimal (except rate of production). Continuous, complete, transparent films with well formed capillaries could be produced optimisation of the protocol. The to films could be filled and/or drawn without leaking. Product morphology was found to change with drawing speed and rate of cooling inline. Fast drawing with no cooling could thin the films to 1 mm wide with microscopic width and capillaries. Drawing with heavy cooling enlarged the voidage in the films.

In another test, uncoated gum pellets were reduced in size to approximately 3 mm to aid feeding into the extruder. This was done with freezing and a domestic food processor. Barrel and die temperatures of 58° C. resulted in the most contiguous product. This product had sufficient integrity to be filled with few leaks. It is likely that using gum base, in particular molten gum base, rather than whole gum would produce films with even greater integrity.

In a further test, chocolate was used as material for extrusion. To gain stable running conditions, the heaters and cooling fans of the extruder were electrically disabled. Direct temperature control was abandoned in favour of relying on the air conditioning of the laboratory. With these modifications the extruder barrel indicated an even 22° C. and it was simple to extrude capillary chocolate in a steady state using molten tempered Cadbury's Dairy Milk® chocolate.

As with hard candy extrusion, it was possible to draw the chocolate extrudate so as to alter the cross sectional geometry, and produce capillaries having diameters or widths of between 0.5 mm and 4 mm.

Air filling was achieved through a simple ambient air-bleed to the nozzles in the die and a cross section of the extrudate is shown in FIG. 8.

Monopropylene glycol filling was achieved at ambient temperature and pressure, with approximately 5 cm liquid depth in the header tank which was in turn approximately 10 cm higher than the die. Colour was added directly into the header tank as and when required.

Golden Syrup filling was achieved by heating the header tank and pipework to 78° C. to fill hard candy, and 58° C. to fill gum. Pressurisation of the header tank was required at the lower temperature to generate syrup flow. Again, colour was added directly into the header tank as and when required.

FIGS. 8-14 shows photographs of extrusions formed in the third phase of experiments. FIG. 8 shows a hard candy with an air fill. FIG. 9 shows a hard candy with a liquid fill. FIG. 9 shows a gum with an air fill, FIG. 10 shows a gum with a liquid fill. FIG. 11 shows a chocolate with an air fill. FIG. 12 shows a chocolate with an air fill as shown in FIG. 11, but in longitudinal cross section.

### Example 3

This example concerns the extrusion of a mixture of a hard candy composition and a chewing gum composition using a capillary die attached to an extrusion apparatus to show that a confectionery product (also referred to as a “crunchy gum”) including an extruded mixture of candy and gum having capillaries disposed therein could be formed.

The hard candy and chewing gum compositions that were employed in this investigation were both sugar-free. The hard candy composition was prepared in the lab using the formula shown in Table 4 below.

TABLE 4
Hard Candy Composition.

| Ingredient | Moisture Content | % Weight | Grams |
|---|---|---|---|
| Maltitol (particulate) | 0% | 44.3% | 1773.6 |
| Hydrogenated starch | 15% | 73.3% | 2931.2 |
| hydrolysates | | | |
| Total (before cooking) | | 117.6% | 4704.8 |
| Total (after cooking) | | 100% | 4000.0 |

The maltitol and hydrogenated starch hydrolysates were added in a pan and heated over a stove top to 185° C. The candy composition was then cooled to 130° C. Additional ingredients are typically added to this composition to give the candy flavor and aroma, but they were not added for the purpose of this experiment. For instance, some of the ingredients that could be added include a variety of optional additives, such as, but not limited to, flavors, acids, sensates, buffers and the like.

The candy composition was further cooled on a tempering table to 80-90° C. This is a slightly elevated temperature, which was maintained to keep the candy composition somewhat malleable for subsequent blending and extrusion in combination with the chewing gum composition.

A finished (i.e., fully prepared) chewing gum composition was obtained from a production site. The chewing gum composition was kept warm in a warming oven at 60° C. The general formula of the chewing gum composition is shown in Table 5 below.

TABLE 5
Chewing Gum Composition.

| Ingredient | % Weight |
|---|---|
| Gum Base | 40% |
| Maltitol | 50% |
| Hydrogenated starch hydrolysates | 10% |
| Lecithin | |
| High intensity sweeteners | |
| Cooling agents | |
| Flavor | |
| Color | |

The crunchy gum was made by combining the chewing gum composition and the candy composition at a ratio of approximately 70:30 (gum:candy) by hand and feeding it into the extruder. The extruder included a circular die with 23 needles having an internal diameter of 1.6 mm. The materials passed through the extruder and the die. The mass at the exit end of the extruder, extrudate, was homogeneously mixed. The extrudate can be re-fed into the extruder again or a different extruder if the mass is not well mixed to assure the desired mix is achieved. The gum:candy ratios can also be varied, for instance, to 90:10, 80:20, 60:40, 50:50 to achieve the desired product attributes. The higher the candy 1 to content the more crunch the final product will have and less chewing experience.

The extruder parameters used in the trial are shown in Table 6 below.

TABLE 6
Extruder Parameters.

| Parameter | Measurement | |
|---|---|---|
| Extrudate/Rope Diameter | 26 | mm |
| Extrudate Temperature | 65-70° | C. |
| Throughput | ~60-80 | Kg/hr |
| Extruder Temperature | 65° | C. |
| Die Temperature | 65° | C. |
| Die Pressure | 7-8 | bar |

The extruder temperature was higher than normal chewing gum processing temperatures but lower than normal candy processing temperatures. This temperature was sufficiently low enough for the candy composition to be malleable and mix with the gum composition.

The capillaries were filled with air in this trial but other fill materials can be injected into the capillaries as described herein. Extrudate samples were collected. The die was changed to a different circular die having 5 needles with an internal diameter of 3.6 mm and additional extrudate samples were collected. The extrudate was cut into pieces and visually examined. The air-filled capillaries could be seen throughout the body of the crunchy gum. FIGS. 22-23 show photographs of the cross-section of extruded crunchy gums prepared in this investigation. FIG. 22 shows the extruded crunchy gum prepared using the circular die having 23 needles with an internal diameter of 1.6 mm. FIG. 23 shows the extruded crunchy gum prepared using the circular die having 5 needles with an internal diameter of 3.6 mm.

### Example 4

This example concerns the extrusion of a mixture of a chewy candy composition and a chewing gum composition using a capillary die attached to an extrusion apparatus.

The chewy candy composition that is employed in this example can be sugared. The chewy candy composition is prepared using the formula shown in Table 7 below.

TABLE 7
Chewy Candy Composition.

| Ingredient | % Weight |
|---|---|
| Sucrose | 20-90% |
| Water | 5-12% |
| Glucose syrup | 20-90% |
| Gelling agent (e.g., gelatin solution) | 0-3.5% |
| Fat | 0-30% |
| Flavors | any amount |
| Colors | any amount |
| Fondant or seeding agent | 0-20% |
| Acids | any amount |
| Total | |

The sucrose, water, glucose syrup, gelatin solution and fat (melted) are weighed, mixed together and a slurry is formed. The mixture is cooked to 150° C. The remaining ingredients in Table 7 are mixed into the batch and it is then cooled down to 40-55° C.

The sugar-free chewing gum composition described in Example 3 can be used in this example, or alternatively, a sugared chewing gum composition can be used to produce a fully sugared product. An example of a suitable sugared chewing gum composition is shown in Table 8 below.

TABLE 8
Chewing Gum Composition.

| Ingredient | % Weight |
|---|---|
| Gum base | 25.0 |
| Lecithin | 0.5 |
| Sugar | 61.5 |
| High Fructose Corn Syrup | 7.0 |
| Glycerin | 0.5 |
| Flavor | 2.45 |
| Intense sweeteners | 3.15 |

The sugared chewing gum composition is prepared by first melting the gum base at a temperature of about 90° C. Once melted, the filler is added to the base and stirred for approximately 0.5 min. Sugar, high fructose corn syrup and glycerin are then added while mixing for 3.5 min. The flavor is mixed and added while mixing for 3.5 min. The intense sweeteners are added and mixed for 3.5 min.

The chewing gum composition is kept warm in a warming oven at 60° C.

The chewy candy/chewing gum product is made by combining the chewing gum composition and the chewy candy composition at a ratio of anywhere from 10:90 to 50:50 (chewy candy:gum) by hand and feeding it into the extruder. The extruder includes a matrix die with 30 needles having an internal diameter of 0.5 mm. The extruder parameters can be any of those described herein, such as in Example 3. The materials pass through the extruder and the die. The mass at the exit end of the extruder, extrudate, is homogeneously mixed. The extrudate can be re-fed into the extruder again or a different extruder if the mass is not well mixed to assure the desired mix is achieved.

The capillaries can be filled with air or other materials. For instance, the capillaries can be filled with a fruit-flavored liquid fill material having the formula shown in Table 9 below.

TABLE 9
Liquid-Fill Material.

| Ingredient | % Weight |
|---|---|
| Glycerin | 63.00 |
| Hydrogenated starch hydrolysates | 29.49 |
| Sorbitol solution | 3.28 |
| Sodium carboxymethyl cellulose | 0.15 |
| Color | 0.0004 |
| Fruit flavour | 4.00 |
| Intense sweetener | 0.02 |

The liquid fill material is prepared by first preparing a pre-mix of the sodium carboxymethyl cellulose, glycerin and polyols. This pre-mix is then combined with the color, flavor and intense sweetener and then mixed. The liquid fill material is maintained in a reservoir that is in fluid communication with the extrusion die. During extrusion of the chewy candy/chewing gum mixture, the liquid fill material is pumped through the needles of the extrusion die and thereby filled into the capillaries as the extrudate is formed. The liquid-filled extrudate is cut into individual pieces and formed into confectionery products. Alternatively, the extrudate can be further stretched by passing it over or through conveyor belts or rollers. The liquid-filled capillaries are reduced in diameter by this stretching step. The stretched extrudate then can be cut into individual pieces and formed into final confectionery products, such as balls, slabs, pellets or the like.

### Example 5

This example concerns the extrusion of a mixture of a chewy candy composition and a hard candy composition using a capillary die attached to an extrusion apparatus.

The chewy candy composition that is employed in this example can be sugar-free. The chewy candy composition is prepared using the formula shown in Table 10 below.

TABLE 10
Chewy Candy Composition.

| Ingredient | % Weight |
|---|---|
| Polydextrose | 28.07 |
| Maltitol | 33.05 |
| Water | 8.13 |
| Dextrin | 7.43 |
| Lecithin | 0.74 |
| Fat | 5.57 |
| Gelatin solution | 3.34 |
| Acids | 13.00 |
| Flavor | 0.63 |
| Intense sweetener | 0.04 |

The polydextrose, maltitol and water are boiled to 120° C. until dissolved. The lecithin and fat are added to the mixture under high-speed mixing. The mixture is cooked to 94.5% solids and then cooled down to 80-90° C. The gelatin solution is then slowly mixed in and the mixture is then cooled to 50° C. The flavor, color and acids then are added.

The sugar-free hard candy composition described in Example 3 can be used in this example to produce a fully sugar-free product.

The chewy candy/hard candy product is made by combining the chewy candy composition and the hard candy composition at a ratio of anywhere from 10:90 to 50:50 (hard candy:chewy candy) by hand and feeding it into the extruder. The extruder includes a circular die with 37 needles having an internal diameter of 1.1 mm. The extruder parameters can be any of those described herein, such as in Example 3. The materials pass through the extruder and the die. The mass at the exit end of the extruder, extrudate, is homogeneously mixed. The extrudate can be re-fed into the extruder again or a different extruder if the mass is not well mixed to assure the desired mix is achieved.

The capillaries can be filled with air or other materials. For instance, the capillaries can be filled with a liquid fill material having the formula shown in Table 11 below.

TABLE 11
Liquid-Fill Material.

| Ingredient | % Weight |
|---|---|
| Glycerin | 63.00 |
| Hydrogenated starch hydrolysates | 29.26 |
| Sorbitol solution | 3.25 |
| Sodium carboxymethyl cellulose | 0.08 |
| Color | 0.004 |
| Flavor | 1.30 |
| Jambu oleoresin | 0.06 |
| Acid | 3.00 |
| Intense sweetener | 0.05 |

The liquid-fill material is prepared by first preparing a pre-mix of the sodium carboxymethyl cellulose, glycerin and polyols. This pre-mix is then combined with the color, flavor, jambu oleoresin, acid and intense sweetener and mixed. The liquid fill material is maintained in a reservoir that is in fluid communication with the extrusion die. During extrusion of the chewy candy/hard candy mixture, the liquid fill material is pumped through the needles of the extrusion die and thereby filled into the capillaries as the extrudate is formed. The liquid-filled extrudate is cut into individual pieces and formed into confectionery products. Alternatively, the extrudate can be further stretched by passing it over or through conveyor belts or rollers. The liquid-filled capillaries are reduced in diameter by this stretching step. The stretched extrudate then can be cut into individual pieces and formed into final confectionery products, such as balls, slabs, pellets or the like.

Confectionery products and methods of the invention have been shown for chocolate, hard candy, gum and various combinations thereof, e.g., crunchy gum. The experiments of the third phase had shown a range of food materials that can also be used. It could therefore be deduced that any product normally solid at room temperature yet extrudable at elevated temperature and pressure could be formed into a capillary product such as chewy, gummy or jelly candies, for example. Products that show high extensional viscosity when warm may be drawn to alter their geometry and their outer to inner ratio.

It has also been shown that air, liquid and solid centres can be incorporated into capillary extrusions, providing the solid centre can be liquefied and is flowable.

It will be apparent to the skilled addressee that the capillary extrudate produced in the examples could be employed in confectionery in a number of ways. For example, a chocolate extrudate having capillaries filled with air could be used to manufacture a chocolate bar having a similar size to a regular bar, but lower in fat and sugar—as it contains less material. Alternatively, a chocolate extrudate could have capillaries filled with a liquid chocolate filling so as to provide an enhanced sensory pleasure. A further example may be a milk chocolate extrudate having capillaries filled with a dark chocolate filling, so as to produce a different flavour profile.

The extrudates of the present invention could be configured in a number of ways. For example, FIGS. 15A and 15B show an extrudate 100 having centre filled capillaries 102, where the extrudate is folded back on it self several times. Such a configuration would enable an extended release of centre fill during chewing. A chocolate éclair could be formed having a chewy centre having liquid filled capillaries—where the chewy centre was a folded several times so as to enable the liquid fill to be released over an extended period.

FIG. 16 shows multiple layers of extrudate 120 being stacked on top of one another and each stack having a plurality of capillaries 122 with a centre filling. Such an arrangement could also be employed in a chewy confectionery. With reference to FIG. 17, a confectionery product 200 is shown which has an extruded body 202, formed from a candy material. Within the extruded body 202 is located a number of parallel capillaries 204 containing liquid fondant. The capillaries 204 have a triangularly shaped cross-section and are arranged such that one side of each triangular edge is maintained equidistant from an adjacent capillary so as to form a row of capillaries which are evenly spaced apart from one another.

Referring now to FIG. 18, there is shown a confectionery product 210 which has an extruded body 212 formed from a candy material. Disposed within the extruded body are three capillaries, all of which have differently shaped cross-sections and all of which contain differently flavoured liquid fondants. The first capillary 214 has a triangular shaped cross-section and is filled with a strawberry flavoured liquid fondant, the second capillary 216 has a star shaped cross-section and is filled with a lime flavoured liquid fondant, whereas the third capillary 218 has a square shaped cross-section filled with a raspberry liquid fondant.

Additionally, the extruded body 212 is provided with some form of portioning means, such as lines of weakness 217, 219 which allows the customer to separate parts of the body containing different capillaries from each other. The lines of weakness 217,219 may be formed during extrusion or introduced after extrusion. This confectionery product not only produces a burst of different flavours in the mouth when consumed, but also provides a product with a novel and attractive centre. Furthermore, by allowing the product to be portioned, if desired, the customer is able to share or choose which flavour is to be consumed.

With reference to FIG. 19, there is shown a confectionery product having the similar features as to that shown in FIG. 18 and similar features are denoted with the same reference numeral prime (′). However, rather than having lines of weakness 217,219, the extruded body is formed into first 222, second 224 and third 226 portions within which are disposed the first 214′, second 216′ and third 218′ capillaries. The portions can be separated from each other easily if desired.

FIG. 20 shows another confectionery product 230 which has an extruded body portion 232 made from a candy material. The cross-section of the extruded body portion is divided into four equal zones. A first set of two diagonally opposed zones 234 is formed simply of the candy material, whereas a second set of two diagonally opposed zones 236 contain a plurality of parallel capillaries 238 which are filled with a liquid fondant. A coating layer of chocolate 240 surrounds the extruded body portion. When consumed, the different zones of the confectionery product produces pleasant sensory mouth feel with the chocolate melting initially, followed by the release of the liquid fondant at the same time as the candy softening and dissolving in the mouth.

FIG. 21 shows a confectionery product 250 which has an extruded body portion 252, within which are disposed capillaries 254 containing a liquid fondant. The space 256 between the capillaries is equal to the thickness to that of the width or diameter of the capillaries.

FIG. 24 shows a confectionery product 260 which has an extruded body portion 262, within which are disposed a plurality of capillaries 264 that are air-filled. The extruded body portion 262 is composed of a homogenous mixture of a hard candy composition and a chewing gum composition. Both the hard candy and chewing gum compositions are sugar-free. The capillaries 264 are centrally grouped within the body portion 262 and surrounded by an outer wall 266 extending to the outer surface 268 of the body portion 262. The outer wall has a thickness of anywhere between 0.1-5 mm.

Although the body portion and capillaries may be depicted as uniform in shape and pattern in some embodiments described herein, it should be understood that the body portion and/or the capillaries may be non-uniform in some embodiments. There may be variations in the overall dimensions of the product, such as, for instance, the dimensions of the body portion, the capillaries, the wall thicknesses between each capillary and the outer wall thickness of the product. For example, in some embodiments, the mechanical process of extrusion and optional further manipulation of the extrudate, such as stretching, may create non-uniformities in the dimensions of the product. Such processes also may create random variations in the positioning of the capillaries. The capillaries accordingly may be irregularly positioned in some embodiments. In addition, the capillaries may be symmetrically disposed in the body portion or asymmetrically disposed in the body portion. In some embodiments, one group of capillaries may be symmetrically disposed and another group of capillaries may be asymmetrically disposed in the body portion.

The foregoing embodiments are not intended to limit the scope of protection afforded by the claims, but rather to describe examples as to how the invention may be put into practice.

1. A confectionery product comprising:
an extruded body portion; and
a plurality of capillaries disposed in said extruded body portion, wherein said body portion comprises a mixture of a hard candy composition and a chewing gum composition.

2. The confectionery product of claim 1, wherein said body portion comprises a homogenous mixture of said hard candy composition and said chewing gum composition.

3. The confectionery product of claim 1, wherein said hard candy composition comprises a hard candy base.

4. The confectionery product of claim 1, wherein said chewing gum composition comprises a chewing gum base.

5. The confectionery product of claim 1, wherein said hard candy composition has a moisture content of about 2-4% by weight.

6. The confectionery product of claim 1, wherein said hard candy composition comprises a cooked saccharide syrup.

7. The confectionery product of claim 1, wherein said hard candy composition is sugar-free.

8. The confectionery product of claim 7, wherein said hard candy composition comprises at least one polyol selected from the group consisting of maltitol, sorbitol, erythritol, isomalt and combinations thereof.

9. The confectionery product of claim 1, wherein said hard candy composition is sugared.

10. The confectionery product of claim 1, wherein said chewing gum composition is sugar-free.

11. The confectionery product of claim 1, wherein said chewing gum composition is sugared.

12. The confectionery product of claim 1, wherein the ratio of said hard candy composition to said chewing gum composition is 10:90 to 50:50.

13. The confectionery product of claim 1, wherein the ratio of said hard candy composition to said chewing gum composition is 20:80 to 40:60.

14. The confectionery product of claim 1, wherein the ratio of said hard candy composition to said chewing gum composition is 30:70.

15. The confectionery product of claim 1, wherein said plurality of capillaries comprises 2-50 capillaries.

16. The confectionery product of claim 1, wherein said plurality of capillaries comprises 30-40 capillaries.

17. The confectionery product of claim 1, wherein said plurality of capillaries in said extruded body portion result in a voidage in the range of 5-40% of said product.

18. The confectionery product of claim 1, wherein said plurality of capillaries in said extruded body portion result in a voidage in the range of 30-40% of said product.

19. The confectionery product of claim 1, wherein said capillaries have an average width or diameter of 0.1-5 mm.

20. The confectionery product of claim 1, wherein said capillaries have an average width or diameter of 0.5-5 mm.

21. The confectionery product of claim 1, wherein said capillaries have an average width or diameter of 0.1-1 mm.

22. The confectionery product of claim 1, wherein said capillaries are separated by a wall thickness of 0.1-3 mm.

23. The confectionery product of claim 1, wherein said capillaries are centrally grouped within said body portion and surrounded by an outer wall extending to the outer surface of said body portion, said wall having a thickness of 0.1-5 mm.

24. The confectionery product of claim 1, wherein said product has a cross-section of 5-30 mm.

25. The confectionery product of claim 1, wherein said product has a piece size of 1-10 g.

26. The confectionery product of claim 1, wherein said capillaries are air-filled.

27. The confectionery product of claim 1, wherein said capillaries are at least partially filled with a fluid material.

28. The confectionery product of claim 27, wherein said fluid comprises a liquid.

29. The confectionery product of claim 27, wherein said fluid comprises a liquid material which solidifies.

30. The confectionery product of claim 1, wherein said product further comprises a coating enveloping said extruded body portion.

31. The confectionery product of claim 1, wherein said capillaries have different widths or diameters.

32. The confectionery product of claim 1, wherein said capillaries have different cross-sectional profiles.

33. The confectionery product of claim 1, further comprising a center-fill region, said capillaries being distributed around the periphery of the body portion and surrounding said center-fill region.

34. The confectionery product of claim 33, wherein said center-fill region comprises a fill material selected from the group consisting of liquids, semi-solids, solids and combinations thereof.

35. A confectionery product comprising:
an extruded body portion; and
a plurality of capillaries disposed in said extruded body portion, wherein said body portion comprises a mixture of a chewy candy composition and a chewing gum composition.

36. The confectionery product of claim 35, wherein said body portion comprises a homogenous mixture of said chewy candy composition and said chewing gum composition.

37. The confectionery product of claim 35, wherein said chewy candy composition comprises a chewy candy base.

38. The confectionery product of claim 35, wherein said chewing gum composition comprises a chewing gum base.

39. The confectionery product of claim 35, wherein said chewy candy composition is sugar-free.

40. The confectionery product of claim 35, wherein said chewy candy composition is sugared.

41. The confectionery product of claim 35, wherein said chewing gum composition is sugar-free.

42. The confectionery product of claim 35, wherein said chewing gum composition is sugared.

43. The confectionery product of claim 35, wherein the ratio of said chewy candy composition to said chewing gum composition is 10:90 to 50:50.

44. The confectionery product of claim 35, wherein said plurality of capillaries comprises 2-50 capillaries.

45. The confectionery product of claim 35, wherein said plurality of capillaries comprises 30-40 capillaries.

46. The confectionery product of claim 35, wherein said plurality of capillaries in said extruded body portion result in a voidage in the range of 5-40% of said product.

47. The confectionery product of claim 35, wherein said plurality of capillaries in said extruded body portion result in a voidage in the range of 30-40% of said product.

48. The confectionery product of claim 35, wherein said capillaries have an average width or diameter of 0.1-5 mm.

49. The confectionery product of claim 35, wherein said capillaries have an average width or diameter of 0.5-5 mm.

50. The confectionery product of claim 35, wherein said capillaries have an average width or diameter of 0.1-1 mm.

51. The confectionery product of claim 35, wherein said capillaries are separated by a wall thickness of 0.1-3 mm.

52. The confectionery product of claim 35, wherein said capillaries are centrally grouped within said body portion and surrounded by an outer wall extending to the outer surface of said body portion, said wall having a thickness of 0.1-5 mm.

53. The confectionery product of claim 35, wherein said product has a cross-section of 5-30 mm.

54. The confectionery product of claim 35, wherein said product has a piece size of 1-10 g.

55. The confectionery product of claim 35, wherein said capillaries are air-filled.

56. The confectionery product of claim 35, wherein said capillaries are at least partially filled with a fluid material.

57. The confectionery product of claim 56, wherein said fluid comprises a liquid.

58. The confectionery product of claim 56, wherein said fluid comprises a liquid material which solidifies.

59. The confectionery product of claim 35, wherein said product further comprises a coating enveloping said extruded body portion.

60. The confectionery product of claim 35, wherein said capillaries have different widths or diameters.

61. The confectionery product of claim 35, wherein said capillaries have different cross-sectional profiles.

62. The confectionery product of claim 35, further comprising a center-fill region, said capillaries being distributed around the periphery of the body portion and surrounding said center-fill region.

63. The confectionery product of claim 62, wherein said center-fill region comprises a fill material selected from the group consisting of liquids, semi-solids, solids and combinations thereof.

64. A confectionery product comprising:
an extruded body portion; and
a plurality of capillaries disposed in said extruded body portion, wherein said body portion comprises a mixture of a chewy candy composition and a hard candy composition.

65. The confectionery product of claim 64, wherein said body portion comprises a homogenous mixture of said chewy candy composition and said hard candy composition.

66. The confectionery product of claim 64, wherein said hard candy composition comprises a hard candy base.

67. The confectionery product of claim 64, wherein said chewy candy composition comprises a chewy candy base.

68. The confectionery product of claim 64, wherein said hard candy composition has a moisture content of about 2-4% by weight.

69. The confectionery product of claim 64, wherein said hard candy composition comprises a cooked saccharide syrup.

70. The confectionery product of claim 64, wherein said hard candy composition is sugar-free.

71. The confectionery product of claim 70, wherein said hard candy composition comprises at least one polyol selected from the group consisting of maltitol, sorbitol, erythritol, isomalt and combinations thereof.

72. The confectionery product of claim 64, wherein said hard candy composition is sugared.

73. The confectionery product of claim 64, wherein said chewy candy composition is sugar-free.

74. The confectionery product of claim 64, wherein said chewy candy composition is sugared.

75. The confectionery product of claim 64, wherein the ratio of said hard candy composition to said chewy candy composition is 10:90 to 50:50.

76. The confectionery product of claim 64, wherein said plurality of capillaries comprises 2-50 capillaries.

77. The confectionery product of claim 64, wherein said plurality of capillaries comprises 30-40 capillaries.

78. The confectionery product of claim 64, wherein said plurality of capillaries in said extruded body portion result in a voidage in the range of 5-40% of said product.

79. The confectionery product of claim 64, wherein said plurality of capillaries in said extruded body portion result in a voidage in the range of 30-40% of said product.

80. The confectionery product of claim 64, wherein said capillaries have an average width or diameter of 0.1-5 mm.

81. The confectionery product of claim 64, wherein said capillaries have an average width or diameter of 0.5-5 mm.

82. The confectionery product of claim 64, wherein said capillaries have an average width or diameter of 0.1-1 mm.

83. The confectionery product of claim 64, wherein said capillaries are separated by a wall thickness of 0.1-3 mm.

84. The confectionery product of claim 64, wherein said capillaries are centrally grouped within said body portion and surrounded by an outer wall extending to the outer surface of said body portion, said wall having a thickness of 0.1-5 mm.

85. The confectionery product of claim 64, wherein said product has a cross-section of 5-30 mm.

86. The confectionery product of claim 64, wherein said product has a piece size of 1-10 g.

87. The confectionery product of claim 64, wherein said capillaries are air-filled.

88. The confectionery product of claim 64, wherein said capillaries are at least partially filled with a fluid material.

89. The confectionery product of claim 88, wherein said fluid comprises a liquid.

90. The confectionery product of claim 88, wherein said fluid comprises a liquid material which solidifies.

91. The confectionery product of claim 64, wherein said product further comprises a coating enveloping said extruded body portion.

92. The confectionery product of claim 64, wherein said capillaries have different widths or diameters.

93. The confectionery product of claim 64, wherein said capillaries have different cross-sectional profiles.

94. The confectionery product of claim 64, further comprising a center-fill region, said capillaries being distributed around the periphery of the body portion and surrounding said center-fill region.

95. The confectionery product of claim 94, wherein said center-fill region comprises a fill material selected from the group consisting of liquids, semi-solids, solids and combinations thereof.

96. A process for manufacturing a confectionery product comprising an extruded body portion having a plurality of capillaries disposed therein, the process comprising the steps of:
a) extruding an extrudable confectionery material with a plurality of capillaries disposed therein, said extrudable confectionery material comprising a mixture of a hard candy composition and a chewing gum composition; and
b) at least partially filling one or more of said capillaries with a fill material.

97. A process for manufacturing a confectionery product comprising an extruded body portion having a plurality of capillaries disposed therein, the process comprising the steps of:
a) extruding an extrudable confectionery material with a plurality of capillaries disposed therein, said extrudable confectionery material comprising a mixture of a chewy candy composition and a chewing gum composition; and
b) at least partially filling one or more of said capillaries with a fill material.

98. A process for manufacturing a confectionery product comprising an extruded body portion having a plurality of capillaries disposed therein, the process comprising the steps of:
a) extruding an extrudable confectionery material with a plurality of capillaries disposed therein, said extrudable confectionery material comprising a mixture of a chewy candy composition and a hard candy composition; and
b) at least partially filling one or more of said capillaries with a fill material.
